(19) United States
(12) Patent Application Publication
(10) Pub. No.: US 2017/0299109 A1
(43) Pub. Date: Oct. 19, 2017

(54) APPARATUS, SYSTEM AND METHODS FOR PROVIDING ACCESSORIES ON A SUPPORT SURFACE

(71) Applicant: NEWPARK MATS & INTEGRATED SERVICES LLC, The Woodlands, TX (US)

(72) Inventors: Billy James McDonald, Lafayette, LA (US); Keegan Blanton McClain, Lafayette, LA (US); Donald Scott Rogers, Lafayette, LA (US); James Kerwin McDowell, Lafayette, LA (US)

(73) Assignee: NEWPARK MATS & INTEGRATED SERVICES LLC, The Woodlands, TX (US)

(21) Appl. No.: 15/484,857

(22) Filed: Apr. 11, 2017

Related U.S. Application Data
(60) Provisional application No. 62/322,458, filed on Apr. 14, 2016.

(51) Int. Cl. F16M 11/04; E01F 9/615; E01F 9/673; E01C 9/08; G09F 7/20; E01F 9/529; G09F 7/18; E01F 9/553; F16B 2/20

(52) U.S. Cl. CPC F16M 11/04; E01F 9/553; E01F 9/615; E01F 9/673; E01C 9/08; G09F 7/20; F16B 2/20; E01F 9/529; G09F 7/18; E01C 9/083; F16M 2200/08; G09F 2007/1817; G09F 2007/1878; E01C 9/086

(57) ABSTRACT

Apparatus, systems and methods for providing one or more accessories on a support surface include a base releasably engageable with the support surface, a housing configured to carry at least a first accessory and be releasably engaged with the base and an elongated carrier rod configured to carry at least a second accessory and be releasably engaged with the base.

The present application claims priority to U.S. Provisional Patent Application Ser. No. 62/322,458 filed on Apr. 14, 2016 and entitled “Apparatus, System and Methods for Providing Accessories on a Support Surface”, which is hereby incorporated by reference herein in its entirety.

### FIELD OF THE DISCLOSURE

The present disclosure relates generally to providing one or more accessories on a support surface.

### BACKGROUND

Temporary or semi-permanent support surfaces and other components have been used for roadways, remote jobsites, industrial staging areas and the like in an ever-increasing myriad of industries, such as construction, military, oilfield, transportation, disaster response, utilities and entertainment. It is sometimes necessary or desirable to provide one or more accessories in the form of signs, markers, road reflectors, fences, safety barriers, warning sirens, beacons or other lights or other components, or a combination thereof, in connection with the support surface. As used herein, the terms “accessory”, “support surface accessory” and variations thereof mean any item or combination of items desired to be visible or audible from a particular location on a support surface. For example, reflectors or lights may be highly beneficial at desired locations on the support surface during nighttime operations (e.g. vehicle and/or equipment movement across the support surface). For another example, it may be highly beneficial to provide warning signs at desired locations on the support surface.

Many of the temporary or semi-permanent support surfaces have holes or cut-outs formed in them. For example, support surfaces are sometimes made up of multiple mats, panels and/or other components. Often, the mats, panels and/or other components include connecting holes formed therein. In use of support surfaces, one or more of the holes may be used to at least temporarily anchor or retain one or more accessories. It is believed that few, if any, apparatus, systems and methods are presently available to provide one or more accessories in connection with a support surface, include different options for the type and location of the accessories and/or include components that are interchangeable, easily and quickly incorporated, removed and replaced, reusable, durable, effective during typical expected use conditions, or a combination thereof.

It should be understood that the above-described features, capabilities and disadvantages are provided for illustrative purposes only and are not intended to limit the scope or subject matter of this disclosure, the appended claims or those of any related patent application or patent. Thus, none of the appended claims or claims of any related application or patent should be limited by the above discussion or construed to address, include or exclude each or any of the above-cited features, capabilities or disadvantages merely because of the mention thereof herein.

Accordingly, there exists a need for improved apparatus, systems and methods for providing one or more accessories in connection with a support surface having one or more of the attributes or capabilities described or shown in, or as may be apparent from, the other portions of this patent.

### BRIEF SUMMARY OF THE DISCLOSURE

In some embodiments, a system for providing multiple accessories on a support surface includes a base configured to be at least partially inserted into at least one hole of the support surface and releasably engaged with the support surface. A housing is releasably engageable with the base and configured to carry at least a first accessory. An elongated carrier rod is configured to carry at least a second accessory and be at least partially, releasably, insertable into at least one bore of the base and engaged with the base. When the carrier rod is engaged with the base and the base is engaged with the support surface, the carrier rod will position the second accessory at a desired height above the support surface. The housing and carrier rod are configured so that one or the other may be engaged with the base or both may be concurrently engaged with the base. The housing is configured to include at least one passageway formed therein, wherein when the housing and carrier rod are concurrently engaged with the base, the passageway(s) of the housing extends through the housing and the carrier rod extends through the passageway(s) of the housing.

In various embodiments, a system for providing multiple accessories on a support surface includes at least one mat at least partially forming the support surface. Each mat includes at least one upper surface, at least one lower surface and at least one hole extending at least partially therethrough. Each mat is configured to support the weight and movement of personnel, vehicles and equipment thereupon. An accessory base includes at least one bore formed therein and is configured to be firmly, releasably secured into at least one hole of at least one of the mats. An accessory housing is configured to carry at least a first accessory and be firmly, releasably engaged with the accessory base. An accessory carrier rod is configured to carry at least a second accessory, be firmly, releasably engaged with the accessory base and extend above at least one upper surface of the mat(s) to position the second accessory at a desired height over the support surface.

There are embodiments that involve a method of providing multiple accessories on a support surface. The support surface includes at least one hole extending at least partially therethrough. The method includes providing at least a first accessory on an accessory housing. At least a second accessory is provided on an accessory carrier rod spaced upwardly from the lower end of the accessory carrier rod. The accessory base is releasably inserted at least partially into at least one hole of the support surface and releasably, rigidly secured to the support surface. The accessory housing is releasably, rigidly secured to the accessory base. The lower end of the accessory carrier rod is releasably inserted through at least one passageway formed in and extending through the accessory housing and into a bore extending at least partially through the accessory base and is releasably, rigidly secured to the accessory base.

Accordingly, the present disclosure includes features and advantages which are believed to enable it to advance support surface accessory technology. Characteristics and advantages of the present disclosure described above and additional features and benefits will be readily apparent to those skilled in the art upon consideration of the following detailed description of various embodiments and referring to the accompanying drawings.

### BRIEF DESCRIPTION OF THE DRAWINGS

The following figures are part of the present specification, included to demonstrate certain aspects of various embodiments of this disclosure and referenced in the detailed description herein:

FIG. 1 is a perspective view of an exemplary mat useful in a support surface in accordance with at least one embodiment of the present disclosure;

FIG. 2 is a top view of a portion of an exemplary support surface useful in accordance with at least one embodiment of the present disclosure;

FIG. 3A is a perspective view of an exemplary hole in an exemplary mat;

FIG. 3B is a partial cross-sectional view of two exemplary mats of an exemplary support surface interconnected with an exemplary locking pin useful in accordance with at least one embodiment of the present disclosure;

FIG. 4A is a side view of an exemplary mat useful in accordance with at least one embodiment of the present disclosure;

FIG. 4B is a perspective view of a borehole equipped with at least one embodiment of a borehole edge seal system useful in accordance with at least one embodiment of the present disclosure;

FIG. 4C is a perspective view of an exemplary support surface that includes multiple mats equipped with at least one embodiment of an electrically-conductive cover and which are electrically coupled together and useful in accordance with at least one embodiment of the present disclosure;

FIG. 5A is a front view of an exemplary support surface accessory system having an exemplary accessory base, accessory housing and vertical assembly in accordance with at least one embodiment of the present disclosure;

FIG. 5B is a cross-sectional view of the exemplary support surface accessory system of FIG. 5A taken along lines FIG. 5B-FIG. 5B;

FIG. 5C is a cross-sectional view of the exemplary support surface accessory system of FIG. 5A taken along lines FIG. 5C-FIG. 5C;

FIG. 6A is a perspective view of an exemplary accessory base in accordance with at least one embodiment of the present disclosure;

FIG. 6B is a top view of the exemplary accessory base of FIG. 6A;

FIG. 6C is a cross-sectional view of the exemplary accessory base of FIG. 6B taken along lines FIG. 6C-FIG. 6C;

FIG. 6D is a side view of the exemplary accessory base of FIG. 6A;

FIG. 6E is a front view of the exemplary accessory base of FIG. 6A;

FIG. 6F is an exploded view of part of the exemplary accessory base shown in FIG. 6E;

FIG. 7A is a top view of an exemplary support surface accessory system having an exemplary accessory housing engaged with an exemplary accessory base, which is engaged with an exemplary support surface in accordance with at least one embodiment of the present disclosure;

FIG. 7B is a side view of the exemplary support surface accessory system shown in FIG. 7A;

FIG. 7C is a cross-sectional view of the exemplary support surface accessory system shown in FIG. 7B taken along lines FIG. 7C-FIG. 7C;

FIG. 7D is a cross-sectional view of the exemplary support surface accessory system shown in FIG. 7B taken along lines FIG. 7D-FIG. 7D;

FIG. 8A is a top view of an exemplary accessory housing in accordance with at least one embodiment of the present disclosure;

FIG. 8B is a perspective view (from below) of the exemplary accessory housing shown in FIG. 8A;

FIG. 8C is a front view of the exemplary accessory housing shown in FIG. 8A;

FIG. 8D is a side view of the exemplary accessory housing shown in FIG. 8A;

FIG. 8E is a cross-sectional view of the exemplary accessory housing shown in FIG. 8D taken along lines FIG. 8E-FIG. 8E;

FIG. 9A is a front view of an exemplary support surface accessory system having an exemplary vertical assembly engaged with an exemplary accessory base, which is engaged with an exemplary support surface in accordance with at least one embodiment of the present disclosure;

FIG. 9B is a cross-sectional view of the exemplary support surface accessory system of FIG. 9A taken along lines FIG. 9B-FIG. 9B;

FIG. 9C is a cross-sectional view of the exemplary support surface accessory system of FIG. 9A taken along lines FIG. 9C-FIG. 9C;

FIG. 10A is a front view of an exemplary support surface accessory system having an exemplary vertical assembly engaged with an exemplary accessory base, which is engaged with an exemplary support surface in accordance with at least one embodiment of the present disclosure;

FIG. 10B is a cross-sectional view of the exemplary support surface accessory system of FIG. 10A taken along lines FIG. 10B-FIG. 10B;

FIG. 10C is a cross-sectional view of the exemplary support surface accessory system of FIG. 10A taken along lines FIG. 10C-FIG. 10C;

FIG. 11A is a front view of an exemplary support surface accessory system having an exemplary vertical assembly engaged with an exemplary accessory base, which is engaged with an exemplary support surface in accordance with at least one embodiment of the present disclosure;

FIG. 11B is a cross-sectional view of the exemplary support surface accessory system of FIG. 11A taken along lines FIG. 11B-FIG. 11B;

FIG. 11C is a cross-sectional view of the exemplary support surface accessory system of FIG. 11A taken along lines FIG. 11B-FIG. 11B;

FIG. 12A is a front view of an exemplary support surface accessory system having an exemplary vertical assembly engaged with an exemplary accessory base, which is engaged with an exemplary support surface in accordance with at least one embodiment of the present disclosure;

FIG. 12B is a cross-sectional view of the exemplary support surface accessory system of FIG. 12A taken along lines FIG. 12B-FIG. 12B;

FIG. 12C is a cross-sectional view of the exemplary support surface accessory system of FIG. 12A taken along lines FIG. 12C-FIG. 12C;

FIG. 13A is a front view of an exemplary raised-position accessory including an exemplary marker and exemplary sleeve in accordance with at least one embodiment of the present disclosure;

FIG. 13B is a side view of the exemplary raised-position accessory of FIG. 13A;

FIG. 13C is a rear view of the exemplary raised-position accessory of FIG. 13A;

FIG. 13D is a perspective view of the exemplary raised-position accessory of FIG. 13A;

FIG. 13E is an exploded view of an exemplary raised-position accessory in the form of data appearing on the front face of the exemplary marker of FIG. 13A;

FIG. 13F is an exploded view of an exemplary raised-position accessory in the form of data appearing on the rear face of the exemplary marker of FIG. 13C;

FIG. 14A is a top view of an exemplary support surface accessory system having an exemplary accessory housing engaged with an exemplary accessory base, which is engaged with an exemplary support surface in accordance with at least one embodiment of the present disclosure;

FIG. 14B is a side view of the exemplary support surface accessory system shown in FIG. 14A;

FIG. 14C is a cross-sectional view of the exemplary support surface accessory system shown in FIG. 14B taken along lines FIG. 14C-FIG. 14C;

FIG. 14D is a cross-sectional view of the exemplary support surface accessory system shown in FIG. 14B taken along lines FIG. 14D-FIG. 14D;

FIG. 15A is a perspective view an exemplary housing accessory in the form of a road reflector in accordance with at least one embodiment of the present disclosure;

FIG. 15B is a front view the exemplary housing accessory of FIG. 15A;

FIG. 15C is an end view the exemplary housing accessory of FIG. 15A;

FIG. 15D is a side view the exemplary housing accessory of FIG. 15A;

FIG. 16A is a perspective view of an exemplary support surface accessory system having an exemplary accessory housing engaged with an exemplary accessory base in accordance with at least one embodiment of the present disclosure;

FIG. 16B is a top view of the exemplary support surface accessory system shown in FIG. 16A;

FIG. 16C is a bottom view of the exemplary support surface accessory system shown in FIG. 16A;

FIG. 16D is an exploded, cross-sectional view of part of the exemplary support surface accessory system of FIG. 16B taken along lines FIG. 16D-;

FIG. 16E is a side view of the exemplary support surface accessory system shown in FIG. 16A;

FIG. 16F is a front view of the exemplary support surface accessory system shown in FIG. 16A;

FIG. 17A is a perspective view of an support surface accessory system having an exemplary vertical assembly engaged with an exemplary accessory base in accordance with at least one embodiment of the present disclosure;

FIG. 17B is a front view of the exemplary support surface accessory system of FIG. 17A;

FIG. 17C is a side view of the exemplary support surface accessory system of FIG. 17A;

FIG. 17D is a cross-sectional view of the exemplary support surface accessory system of FIG. 17C taken along lines FIG. 17D-FIG. 17D;

FIG. 18A is a front view of an exemplary raised-position accessory having an exemplary marker and exemplary sleeve in accordance with at least one embodiment of the present disclosure;

FIG. 18B is a top view of the exemplary raised-position accessory of FIG. 18A;

FIG. 18C is a cross-sectional view of the exemplary raised-position accessory of FIG. 18B taken along lines FIG. 18C-FIG. 18C;

FIG. 18D is a perspective view of the exemplary raised-position accessory of FIG. 18A;

FIG. 18E is an exploded view of part of the exemplary raised-position accessory of FIG. 18D;

FIG. 19A is a front view of another exemplary raised-position accessory having an exemplary marker and exemplary sleeve in accordance with at least one embodiment of the present disclosure;

FIG. 19B is a top view of the exemplary raised-position accessory of FIG. 19A;

FIG. 19C is a cross-sectional view of the exemplary raised-position accessory of FIG. 19B taken along lines FIG. 19C-FIG. 19C;

FIG. 19D is a perspective view of the exemplary raised-position accessory of FIG. 19A;

FIG. 19E is an exploded view of part of the exemplary raised-position accessory of FIG. 19D;

FIG. 20A is a perspective view of an exemplary carrier rod of an exemplary vertical assembly in accordance with at least one embodiment of the present disclosure;

FIG. 20B is an exploded view of the lower end of the exemplary carrier rod of FIG. 20A; and

FIG. 20C is a front view of the exemplary carrier rod of FIG. 20A.

### DETAILED DESCRIPTION OF PREFERRED EMBODIMENTS

Characteristics and advantages of the present disclosure and additional features and benefits will be readily apparent to those skilled in the art upon consideration of the following detailed description of exemplary embodiments of the present disclosure and referring to the accompanying figures. It should be understood that the description herein and appended drawings, being of example embodiments, are not intended to limit the claims of this patent application or any patent or patent application claiming priority hereto. On the contrary, the intention is to cover all modifications, equivalents and alternatives falling within the spirit and scope of this disclosure or any appended claims. Many changes may be made to the particular embodiments and details disclosed herein without departing from such spirit and scope.

In showing and describing preferred embodiments in the appended figures, common or similar elements are referenced with like or identical reference numerals or are apparent from the figures and/or the description herein. The figures are not necessarily to scale and certain features and certain views of the figures may be shown exaggerated in scale or in schematic in the interest of clarity and conciseness.

As used herein and throughout various portions (and headings) of this patent, the terms “invention”, “present invention” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference. The terms “coupled”, “connected”, “engaged”, “secured” and the like, and variations thereof, as used herein and in the appended claims are intended to mean either an indirect or direct connection or engagement. Thus, if a first device couples to a second device, that connection may be through a direct connection, or through an indirect connection via other devices and connections.

Certain terms are used herein and in the appended claims to refer to particular components. As one skilled in the art will appreciate, different persons may refer to a component by different names. The use of a particular or known term of art as the name of a component herein is not intended to limit that component to only the known or defined meaning of such term (e.g. bar, connector, rod, cover, panel, bolt). Further, this document does not intend to distinguish between components that differ in name but not function. Also, the terms “including” and “comprising” are used herein and in the appended claims in an open-ended fashion, and thus should be interpreted to mean “including, but not limited to . . . .” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

As used herein, the terms “substantially”, “generally” and variations thereof means and includes (i) completely, or 100%, of the referenced parameter, variable or value and (ii) a range of values less than 100% based upon the typical, normal or expected degree of variation or error for the referenced parameter, variable or value in the context of the particular embodiment or use thereof, such as, for example, 90-100%, 95-100% or 98-100%. However, in some instances of the use of the terms “generally”, “substantially” and variations thereof herein, the above definition may not apply, as should be apparent from the context of such use.

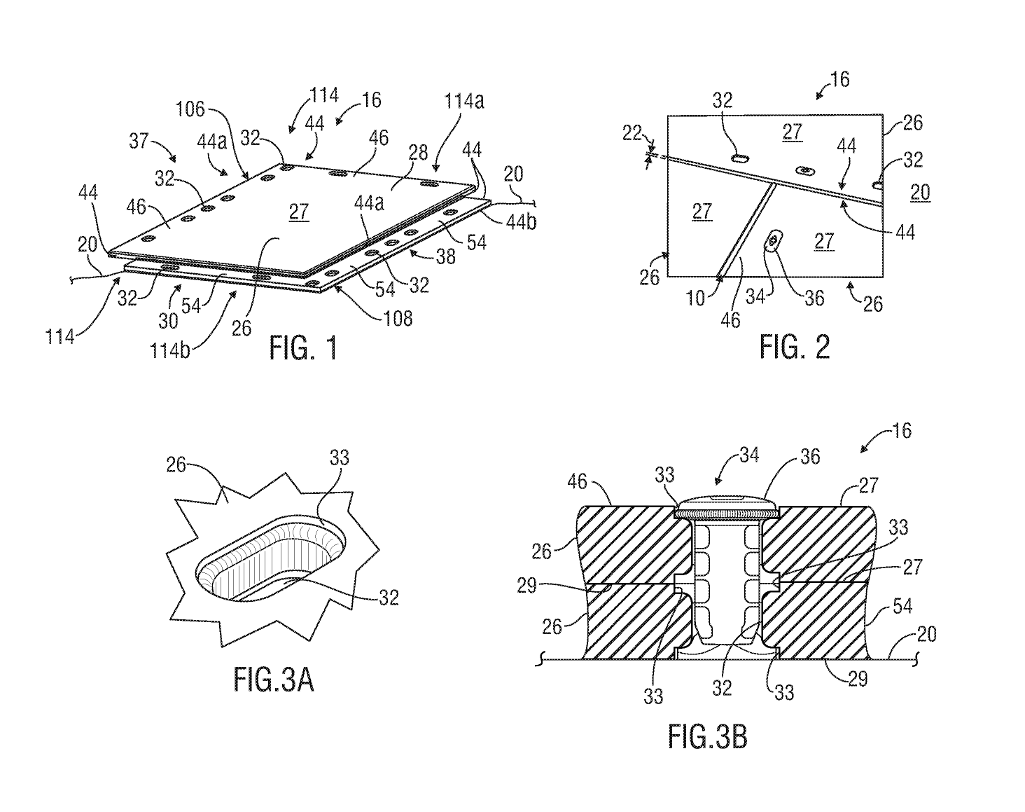

Referring initially to FIGS. 1 and 2, an exemplary support surface 16 having at least one mat 26 deployed on or near the ground 20 is shown. As used herein, the term “ground” and variations thereof mean the earth's surface, and/or other one or more other surfaces, structures or areas proximate to or associated with the earth's surface. In the present embodiment, the support surface 16 is reusable and capable of supporting the weight of vehicles, equipment and/or other structures thereupon. The illustrated support surface 16 includes at least two interconnected adjacent mats 26.

The mats 26 may have any suitable form, construction, components, configuration and operation. Some examples of mats 26 which may be used in various embodiments of the present disclosure are shown and described in in U.S. Pat. No. 5,653,551 to Seaux, entitled “Mat System for Construction of Roadways and Support Surfaces” and issued on Aug. 5, 1997, and U.S. Pat. No. 6,511,257 to Seaux et al., entitled “Interlocking Mat System for Construction of Load Supporting Surfaces” and issued on Jan. 28, 2003, both of which have a common Assignee as the present patent application and the entire contents of which are hereby incorporated by reference herein in their entireties. For example, each exemplary mat 26 may weight approximately 1,000 lbs., be designed to withstand up to 600 psi in pure crush pressure placed thereupon, reduce point-to-point ground pressure on the ground 20 that may be caused by wheeled and/or tracked vehicles on the mat 26 or a combination thereof. In some embodiments, the mats 26 may be 14′×8′ DURA-BASE® mats currently sold by the Assignee of this patent application.

If desired, the support surface 16 may be used in connection with any of the components and features described and shown in U.S. Pat. No. 9,132,996 issued on Sep. 15, 2015 to Robertson and entitled “Crane-Mounted Grab Head”, U.S. Pat. No. 7,370,452 issued on May 13, 2008 to Rogers and entitled “Mat Assembly for Heavy Equipment Transit and Support”, U.S. Pat. No. 9,039,325 issued on May 26, 2015 to McDowell and entitled “Liquid Containment System for Use with Support Surfaces”, U.S. patent application Ser. No. 14/720,799, filed on May 24, 2015 and entitled “Liquid Containment System”, U.S. Pat. No. 9,430,943 issued on Aug. 30, 2016 and entitled “Apparatus and Methods for Providing Illuminated Signals from a Support Surface”, U.S. patent application Ser. No. 14/496,105, U.S. Pat. No. 9,337,586 issued on May 10, 2016 and entitled “Apparatus & Methods for Electrically Grounding a Load-Supporting Support Surface”, U.S. Pat. No. 9,368,918 issued on Jun. 14, 2016 and entitled “Apparatus & Methods for Electrically Grounding a Load-Supporting Support Surface”, U.S. Pat. No. 9,297,124 issued on Mar. 29, 2016 and entitled “Methods of Moving at Least One Mat With a Crane-Mounted Grab Head”, U.S. Provisional Patent Application Ser. No. 62/151,817, filed on Apr. 23, 2015 and entitled “Apparatus & Methods for Supporting One or More Upright Items From a Support Surface”, each of which has a common Assignee as the present patent application and the entire contents of which are hereby incorporated by reference herein in their entireties.

Still referring to FIGS. 1 and 2, in the illustrated embodiment, each mat 26 is generally flat, or planar, heavy duty, durable and all-weather. The exemplary mats 26 are reusable and interlock together to form at least part of the support surface 16. Each illustrated mat 26 has a stepped-configuration and is constructed of impermeable material, such as thermoplastic. As used herein, the terms “stepped-configuration” and variations thereof mean the mat 26 has at least one portion that extends at least partially on a different plane than at least one other portion and the planes are at least substantially parallel. Other example mats 26 may be constructed entirely or partially of wood, steel, steel-framed wood, aluminum, rubber, plastic, fiberglass, fiber reinforced plastic, recycled rubber or materials or any other desired material or combination thereof.

Referring specifically to FIG. 1, the illustrated mat 26 has a rectangular shape with an opposing pair of short sides 28, 30, an opposing pair of long sides 37, 38, and at least one edge 44 (e.g. edge 44a) extending along each side 28, 30, 37 and 38 and around a perimeter 114 (e.g. perimeter 114a) of the mat 26. In this particular example, the mat 26 is constructed of upper and lower engaged offset panels 106, 108 and is reversible. In other words, the top and bottom of the illustrated mat 26 are mirror images of one another, so either the top or bottom can be facing up or down and interconnected with other mats or other components of a support surface 16. The illustrated mat 26 thus has a first, upper set of aligned edges 44a extending around an “upper” perimeter 114a (formed around the upper panel 106), and a second, lower, set of aligned edges 44b extending around a “lower” perimeter 114b (formed around the lower panel 108). However, in other embodiments, the mat 26 may be a single unitary item or a combination of more than two component parts, may not be reversible, may have only one, or more than two, perimeters 114, may not be interconnectable with other mats 26 or other components, or any desired combination thereof.

In this example, the first short side 28 and first long side 37 each have an upper lip 46 extending horizontally outwardly therefrom, which will typically be spaced above the ground 20. The illustrated second short side 30 and second long side 38 each have a lower lip 54 extending horizontally outwardly therefrom, and which will typically rest on the ground 20. Thus, in this embodiment, two sets of aligned edges 44a, 44b are formed around the sides 28, 30, 37 and 38.

The upper and lower lips 46, 54 may have any suitable size, shape, configuration and length. It should be understood, however, that the present disclosure is not limited to use with the above-described embodiments of mats 26 having upper and/or lower lips 46, 54 or a stepped-configuration. For example, the support surface accessory system 400 of the present disclosure may be used in connection with mats 26 not having upper and/or lower lips 46, 54 or a stepped-configuration. Further, the support surface accessory system 400 of the present disclosure may be used with mats 26 and/or other components of a support surface 16 which are not interconnectable.

Referring back to FIGS. 1 & 2, many temporary or semi-permanent support surfaces have holes (cut-outs, orifices, cavities, etc.) 32 formed in them. For example, support surfaces 16 made up of multiple mats, panels and/or other components often include connecting holes 32 formed therein. In some instances, the mats, panels and/or other components include holes (cut-outs, orifices, cavities, etc.) 32 that can be aligned over or under those of adjacent mats/panels/components and through which removable locking pins 34 are inserted for connecting the mats/components together. These sorts of holes 32 are sometimes referred to herein as “locking pin” holes. The terms “hole”, “connecting hole”, “locking pin hole” and variations thereof are used interchangeably herein and in the appended claims. Further, the designed purpose of any particular “hole” (e.g. for connecting, for receiving a locking pin, etc.) is not relevant or restrictive upon the present disclosure or appended claims, unless specifically stated so in a particular instance.

Referring still to FIGS. 1 & 2, in this example, the respective upper and lower lips 46, 54 of different mats 26 are interconnectable with locking pins 34 releasably securable through corresponding holes 32 formed therein. The holes 32 and locking pins 34 may have any suitable form, construction, configuration, components and operation. In this embodiment, the illustrated mats 26 include a plurality of locking pin holes 32, each configured to accept a releasable locking pin 34 therethrough. Each illustrated mat 26 may include, for example, a total of sixteen locking pin holes 32, eight locking pin holes 32 formed in each set of upper and lower lips 46, 54.

Some examples of locking pins 34 that may be used in various embodiments of the present disclosure are shown and described in U.S. Pat. No. 6,722,831 to Rogers et al, entitled “Fastening Device” and issued on Apr. 20, 2004, U.S. Pat. No. 8,388,291 to Rogers, entitled “Mat Lock Pin” and issued on Mar. 5, 2013, U.S. Pat. No. 9,068,584 to McDowell et al, entitled and “Apparatus & Methods for Connecting Mats” and issued on Jun. 30, 2015, U.S. Provisional Patent Application Ser. No. 62/216,542, entitled “Apparatus for Connecting Mats and/or Other Components and Methods of Assembly and Use Thereof” and filed on Sep. 10, 2015, each of which has a common Assignee as the present patent application and the entire contents of which are hereby incorporated by reference herein in its entirety. In some embodiments, the locking pins 34 may form a fluid-tight seal around, or in, the holes 32 within which they are engaged, such as the exemplary locking pin 34 illustrated and described in U.S. Provisional Patent Application Ser. No. 61/748,818, entitled “Apparatus and Methods for Connecting Mats” and filed on Jan. 14, 2013, U.S. Pat. No. 9,068,584 and U.S. patent application Ser. No. 14/752,067 entitled “Adjustable Mat Locking Pin and Methods of Use Thereof” and filed on Jun. 26, 2015, all of which have a common Assignee as the present patent application and the entire contents of which are hereby incorporated by reference herein in their entireties.

Referring to FIGS. 3A & 3B, the illustrated holes 32 of the mats 26 have a non-circular cross-sectional shape. In this example, the locking pin holes 32 have an oval shape, such as to accept an oval-shaped enlarged head 36 of the illustrated locking pins 34. An oval-shaped recess, or indentation, 33 is formed in the upper and lower surfaces 27, 29 of each exemplary mat 26 around each locking pin hole 32. In this embodiment, the indentation 33 is also oval and configured to at last partially seat the oval-shaped enlarged head 36 of the illustrated locking pin 34.

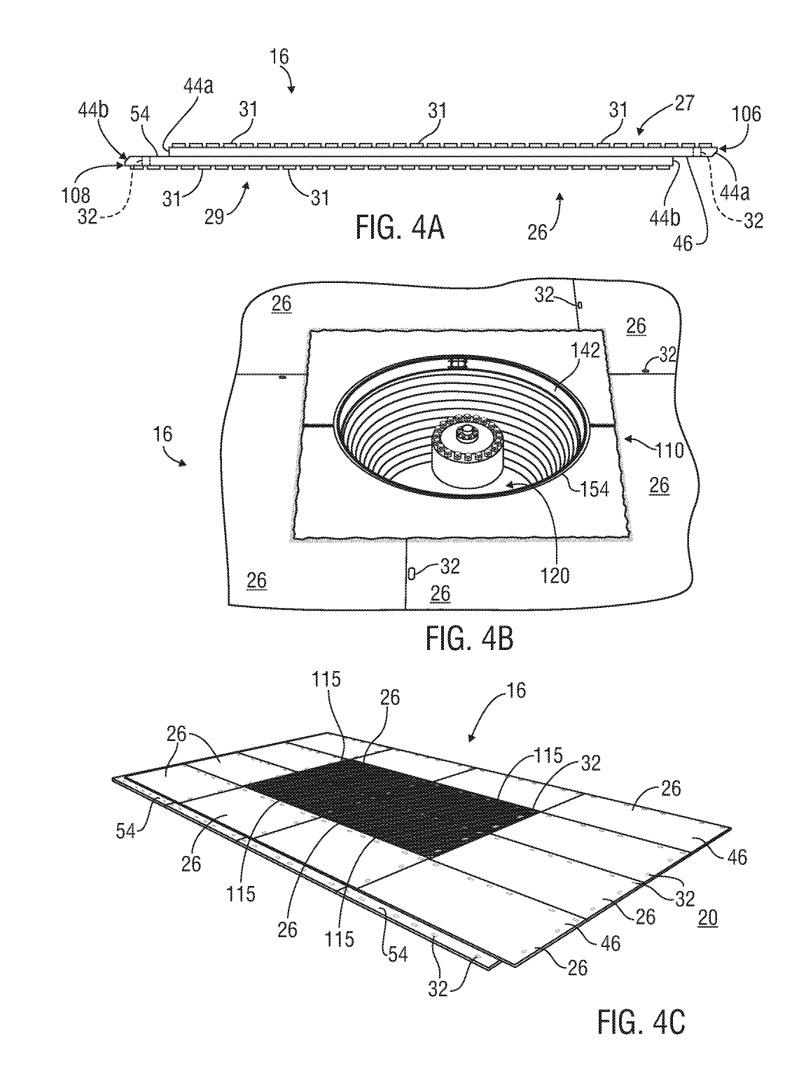

As shown in FIG. 4A, in some embodiments, the upper and lower surfaces 27, 29 of the mat 26 may include raised traction promoting elements, or treads, 31 formed in or extending from the mat 26. However, in some stepped-configuration embodiments, the treads 31 may not be included on the underside of each panel 106, 108 of the mat 26 that extends beyond the other respective panel 106, 108. In other words, in the illustrated mat 26, the upper surface 27 of the mat 26 that forms the lower lip 54 (which is the portion of panel 108 that extends beyond panel 106) is absent the treads 31. Thus, the holes 32 on the exemplary upper lip 46 are surrounded by treads 31, while the holes 32 on the illustrated lower lip 54 are not surrounded by treads 31. Of course, when the same mat 26 is turned over, the former lower lip 54 (absent treads 31) becomes an upper lip 46 having treads 31. Some exemplary raised traction promoting elements that may be used on the mats 26 in some embodiments are shown and described in U.S. Pat. No. 6,511,257.

It should be noted, however, that the present disclosure is not limited to use with the above-described or referenced types and configurations of support surfaces 16, mats 26, locking pins 34 and holes 32, or to the disclosures of the above-referenced patents and patent applications. Any suitable support surfaces, mats, locking pins and holes may be used.

Referring to FIG. 2, in some embodiments, a gap 22 may be formed between adjacent edges 44 of adjacent interconnected mats 26 in the support surface 16, and one or more seal members 10 may be included therein. For example, the seal member(s) 10 may provide a liquid-tight seal in the gap 22 between adjacent mats 26 to prevent liquid introduced onto the support surface 16 from seeping or flowing between mats 26 and/or other components and below the support surface 16.

Some embodiments of seal members 10 that may be used in the gaps 22 are disclosed in U.S. Pat. No. 9,212,746 to McDowell, issued on Dec. 15, 2015 and entitled “Apparatus and Methods for Sealing Between Adjacent Components of a Load-Supporting Surface”, U.S. Pat. No. 9,499,946, issued on Nov. 22, 2016 and entitled “Method of Sealing Between Adjacent Components of a Load-Supporting Surface With at Least One Closed-Cell Compressible Rubber Seal”, U.S. patent application Ser. No. 14/730,938, filed on Jun. 4, 2015 and entitled “Load-Supporting Surface with Actively Connected Gap Seals and Related Apparatus and Methods”, and U.S. Pat. No. 9,404,227 issued on Aug. 2, 2016 and entitled “Load-Supporting Surface with Interfacing Gap Seal Members and Related Apparatus and Methods”, all of which have a common Assignee as the present patent application and the entire contents of which are hereby incorporated by reference herein in their entireties.

The support surface 16 may include or be associated with other components, and the seal member(s) 10 may also or instead be used between any combination of mats 26 and other components associated with the support surface 16. Some examples of such additional components that may be useful in connection with support surfaces 16, such as berm members, spacers, drive-over barriers, liquid drain assemblies, etc., are shown and disclosed in U.S. Pat. No. 9,039,325.

In some instances, such as shown in FIG. 4B, the support surface 16 may be used around an underground borehole 120, such as with the use of a borehole edge seal system 110. Various embodiments of exemplary borehole edge seal systems 110 are shown and described in U.S. patent application Ser. No. 14/497,429, entitled “Apparatus and Methods for Sealing Around the Opening to an Underground Borehole” and filed on Sep. 26, 2014 and U.S. patent application Ser. No. 14/666,584 entitled “Apparatus and Methods for Mechanically Coupling a Sealing System Around the Opening to an Underground Borehole” and filed on Mar. 24, 2015, both of which have a common Assignee as the present patent application and the entire contents of which are hereby incorporated by reference herein in their entireties.

In various embodiments, such as shown in FIG. 4C, one or more electrically-conductive covers 115 may be used in connection with the support surface 16. Various embodiments of electrically-conductive covers are shown and described in U.S. Pat. Nos. 9,337,586 and 9,368,918. If desired, one or more illuminators (not shown) may be used in connection with the support surface 16. Various embodiments of illuminators are shown and described in U.S. Pat. No. 9,430,943.

However, it should be understood that none of the particular embodiments or features described or shown in FIGS. 1-4C, or in the above-referenced patents and patent applications, is required for, or limiting upon, the present disclosure unless and only to the extent as may be explicitly required in a particular claim hereof or in a patent claiming priority hereto and only for such claim and any claims depending therefrom.

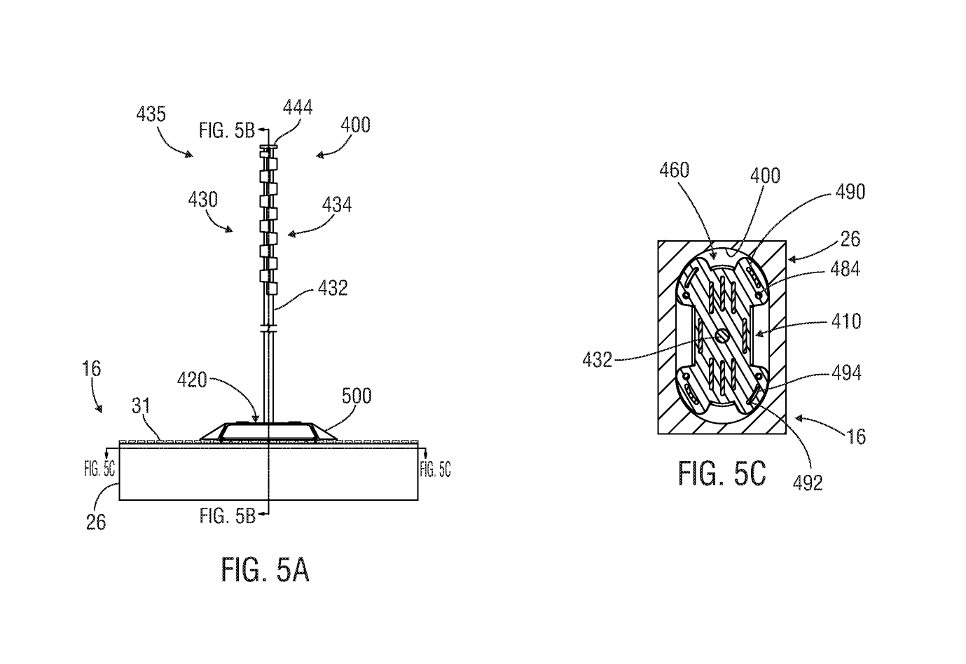

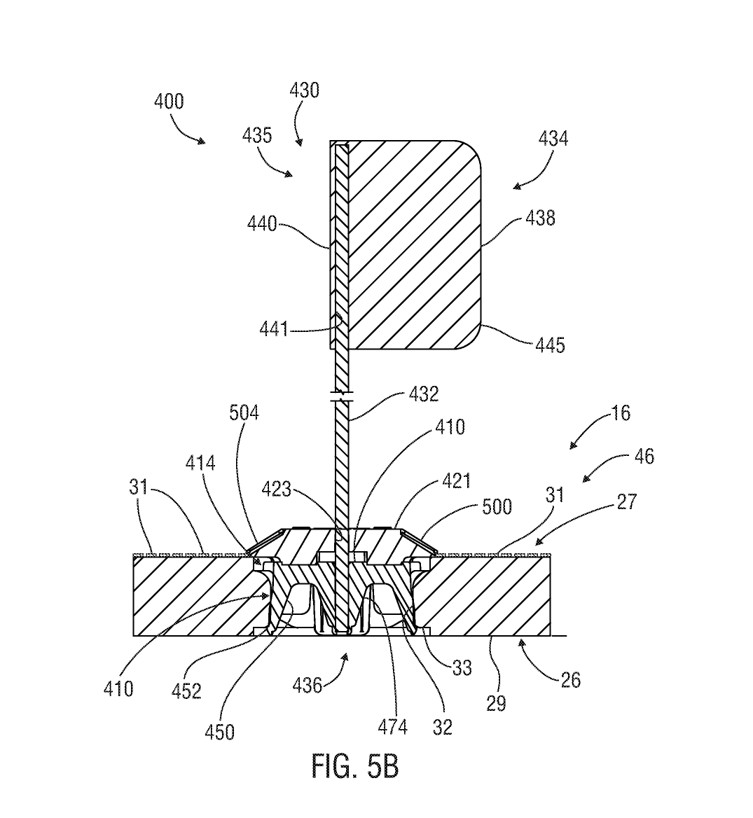

Now referring to FIGS. 5A-C, an embodiment of a support surface accessory system 400 is shown. In this example, the system 400 is shown including an accessory base 410 releasably coupled to the illustrated support surface 16 and at least one accessory housing 420 and vertical assembly 430 releasably coupled to the base 410. The illustrated housing 420 is configured to carry at least one housing accessory 500 The illustrated vertical assembly 430 includes at least one carrier rod 432 configured to carry at least one raised-position accessory 434. As used throughout this patent (including the appended claims), the term “vertical” and variations thereof means, includes and refers to perfectly vertical, angled (not perfectly vertical) or otherwise extending in a non-horizontal manner or orientation. For example, the “vertical assembly” 430 as used in the context of the present disclosure is not limited to having only a perfectly vertical orientation, but instead means and includes any orientation that is not horizontal relative to a support surface 16 or mat 26 with which it is used. In the present embodiment, the exemplary base 410, housing 420 and vertical assembly 430 are durable, such as to withstand potentially-severe outdoor weather conditions (e.g. wind, rain, hail, snow), extreme environmental conditions (e.g. heat, cold) and rugged usage conditions (e.g. heavy equipment moving across and/or being positioned on the support surface 16).

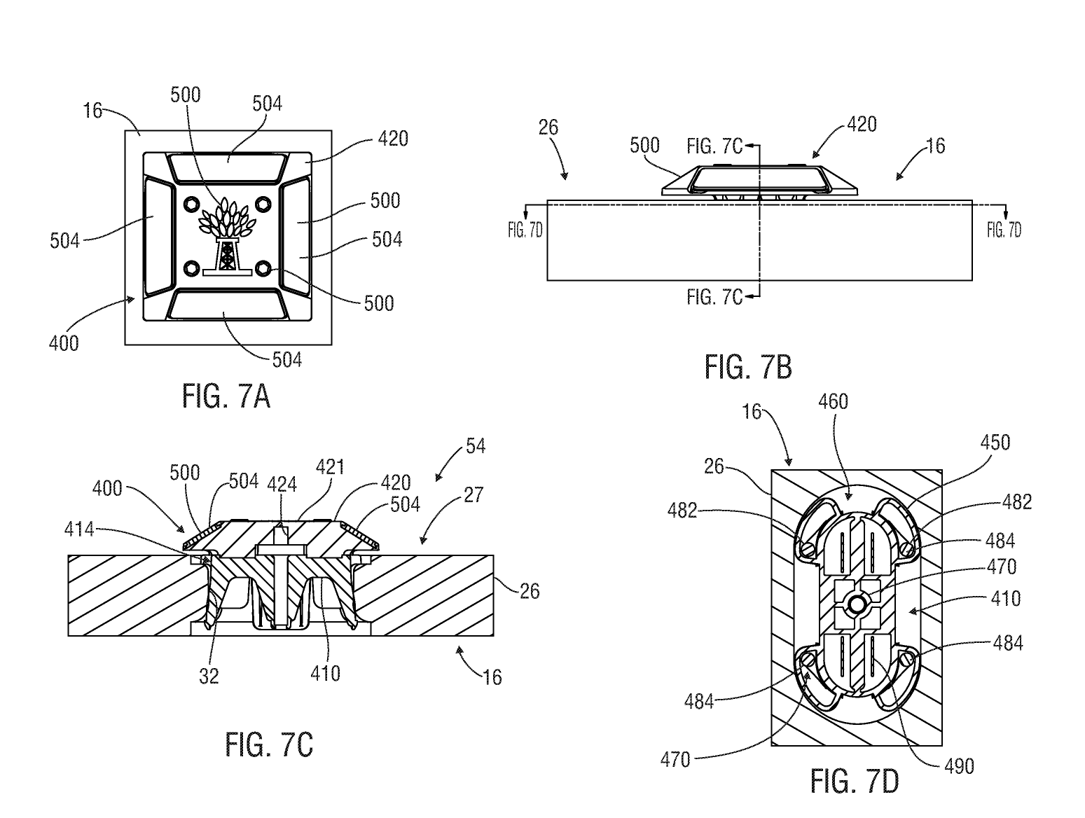

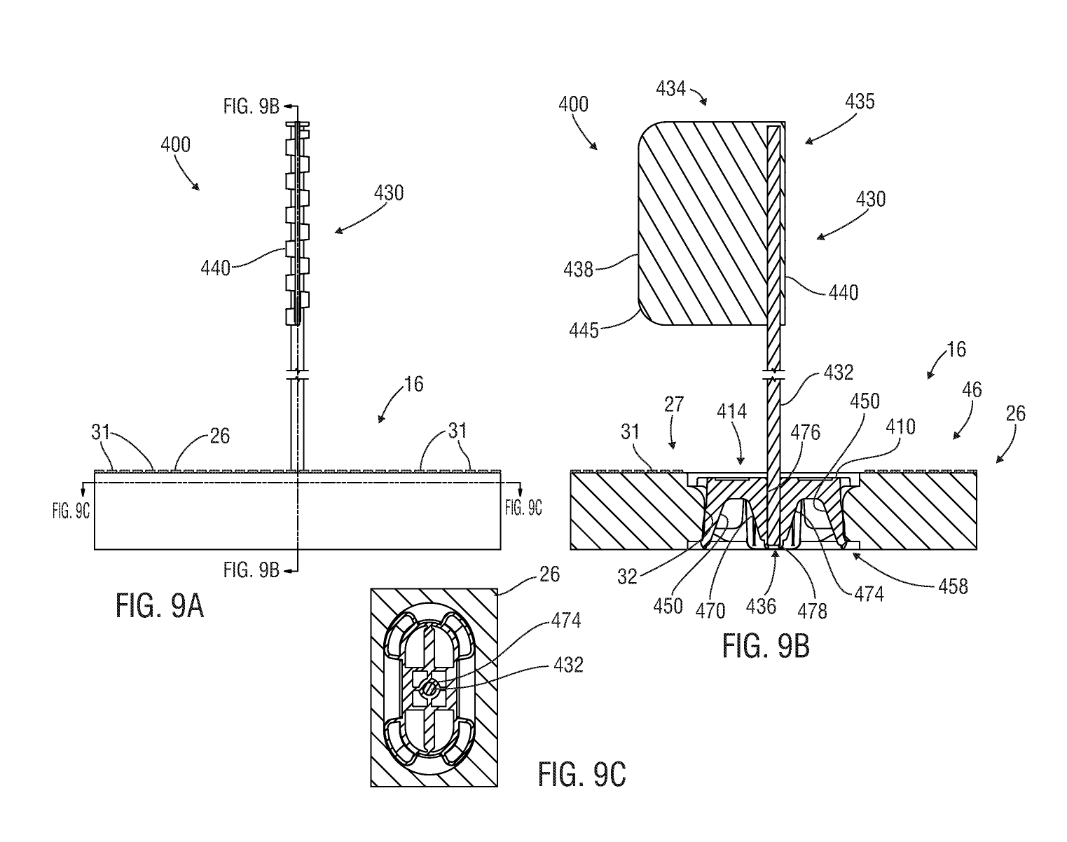

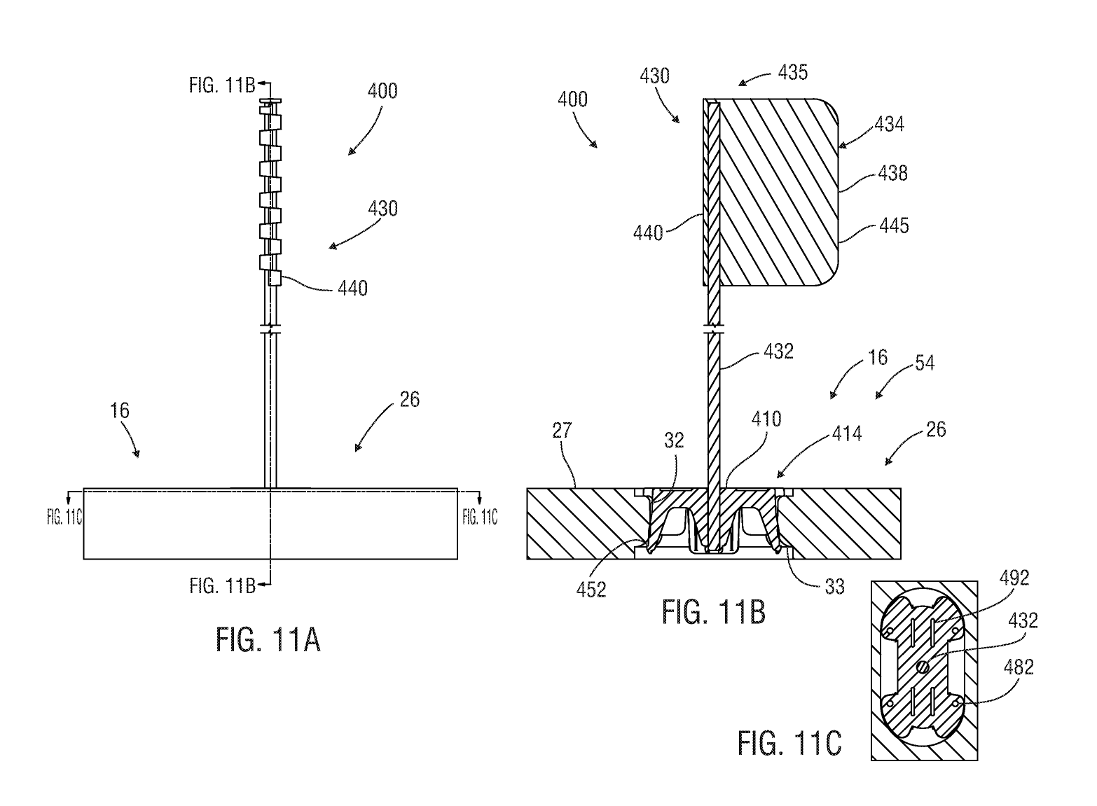

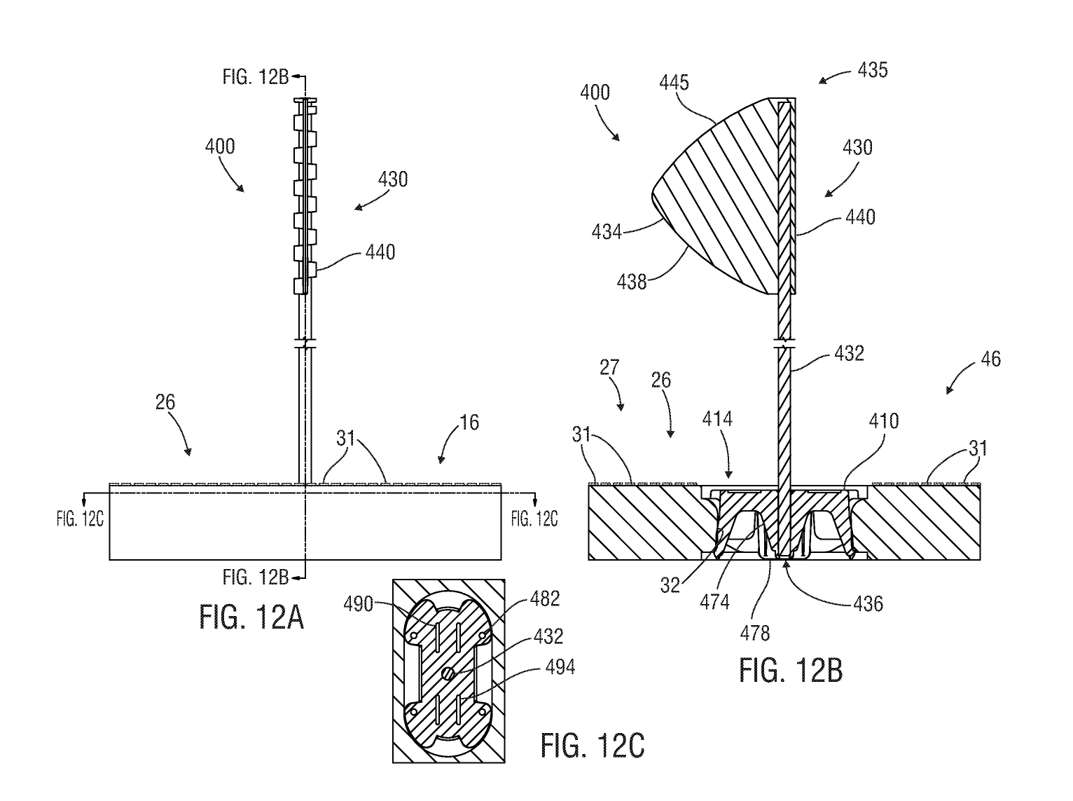

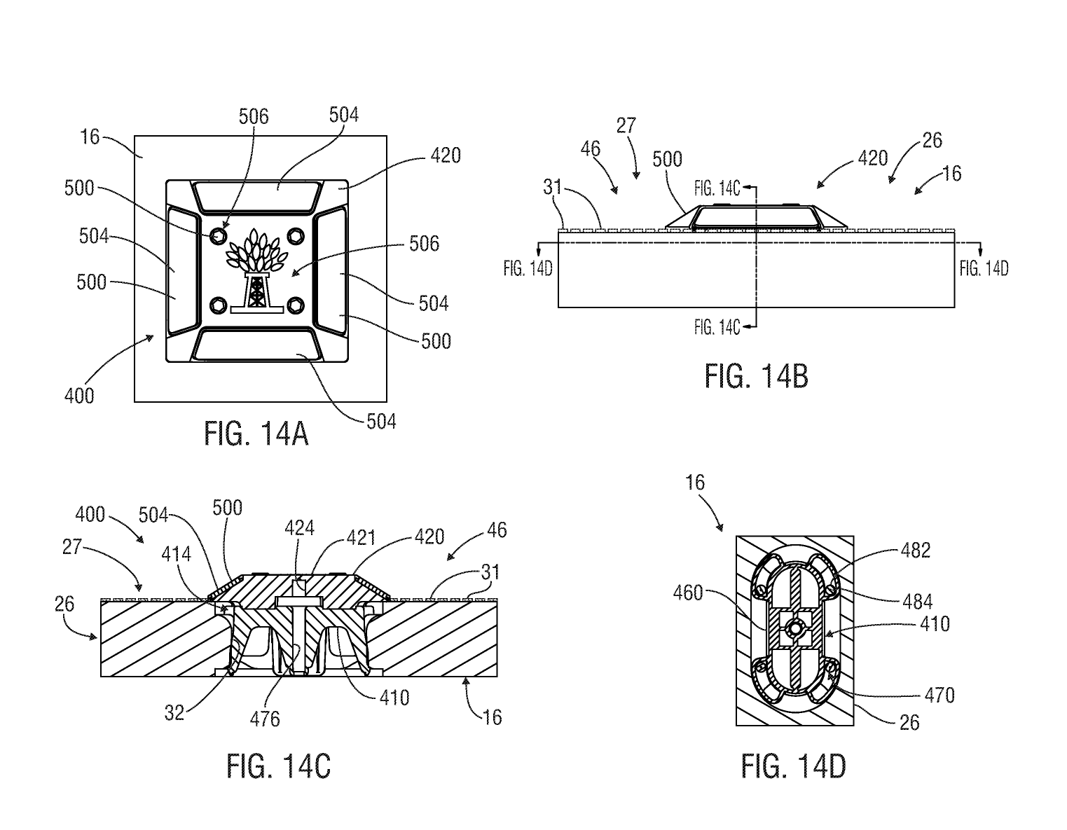

In this embodiment, the exemplary housing 420 and vertical assembly 430 are configured so that one or the other may be used with the base 410, or both may be used concurrently. In other words, the illustrated embodiment has three configurations: (i) the base 410 and the housing 420; (ii) the base 410 and the vertical assembly 430; and (iii) the base 410, the housing 420 and the vertical assembly 430. Thus, in some embodiments, the support surface accessory system 400 may include only an accessory base 410 and accessory housing 420 (e.g. FIGS. 7A-D, FIGS. 14A-D), and in other embodiments may only include an accessory base 410 and a vertical assembly 430 (e.g. FIGS. 9A-12C). For the purposes of this detailed description, all three components will be described with respect to the exemplary embodiments. However, it should be kept in mind that, in some embodiments, the base 410 and only one among the housing 420 and vertical assembly 430 may be included. Furthermore, these components may be selectively positioned at any desired and suitable location on the support surface 16 and thereafter removed, moved to another location, reused, etc.

In some embodiments, the base 410 is configured to be releasably, rigidly secured to or engaged with the support surface 16, the housing 420 is configured to be releasably, rigidly secured to or engaged with the base 410 and the carrier rod 432 is configured to be releasably, rigidly secured to or engaged with base 410. As used throughout this patent (including the appended claims), the terms “rigid”, “rigidly” and variations thereof used herein in the context of the engagement or securing together of two or more components mean the components are engaged or secured together sufficient to stabilize the component(s) on the support surface 16 and/or ensure the engaged components will not disengage from one another (or the support surface 16) during normal or expected use conditions. For example, rigid engagement in the context of the illustrated embodiments includes engagement sufficient to maintain the engaged relationship and desired position of the engaged components relative to the support surface 16 during potentially-severe outdoor weather conditions (e.g. wind, rain, hail, snow), extreme environmental conditions (e.g. heat, cold) and rugged usage conditions (e.g. heavy equipment moving across and/or being positioned on the support surface 16).

In various embodiments, the base 410 is configured to be secured in locking engagement with the support surface 16, the housing 420 is configured to be secured in locking engagement with the base 410 and the carrier rod 432 is configured to be secured in locking engagement with the base 410. As used throughout this patent (including the appended claims), the terms “lock”, “locking” and variations thereof used herein in the context of the engagement or securing together of two or more components mean the components are engaged or secured in a manner that requires affirmative action by one or more persons, tools, machines or a combination thereof to disengage the components.

Still referring to FIGS. 5A-C, the accessory base 410 may have any suitable form, configuration, components, construction and operation. In this embodiment, the base 410 is a single integrally-formed, molded-plastic component. In other embodiments, the base 410 may be multiple components temporarily or permanently coupled together and constructed of any other suitable material. Referring specifically to FIG. 5B, the exemplary accessory base 410 is arranged and configured to be at least partially inserted into one of the locking pin holes 32 formed in the mat 26 and releasably engage the mat 26. It should be understood, however, the accessory base 410 may be inserted into a locking pin hole 32 formed in another component of a support surface 16 or any other type of hole, cut-out or other opening formed in a panel, mat or other component of a support surface 16. In some embodiments, the accessory base 410 may be inserted into multiple aligned locking pin holes 32 (or other holes or cut-outs) formed in multiple overlapping mats 26, panels and/or other components of the support surface 16.

In this embodiment, the accessory base 410 is shaped and configured to be releasably seated or secured in one of the holes 32 and engage the mat 26 sufficient to support and stabilize the accessory housing 420 and/or vertical assembly 430 during typical or expected use conditions. In some embodiments, robust, rigid, locking engagement of the base 410 and the mat 26 (at the locking pin hole 32 or other hole or opening) is necessary and/or desirable, such as to maintain the position of the support surface accessory system 400 during potentially-severe weather (e.g. wind), extreme environmental (e.g. hot, cold) and rugged usage conditions (e.g. heavy equipment moving across and/or being positioned on the support surface 16).

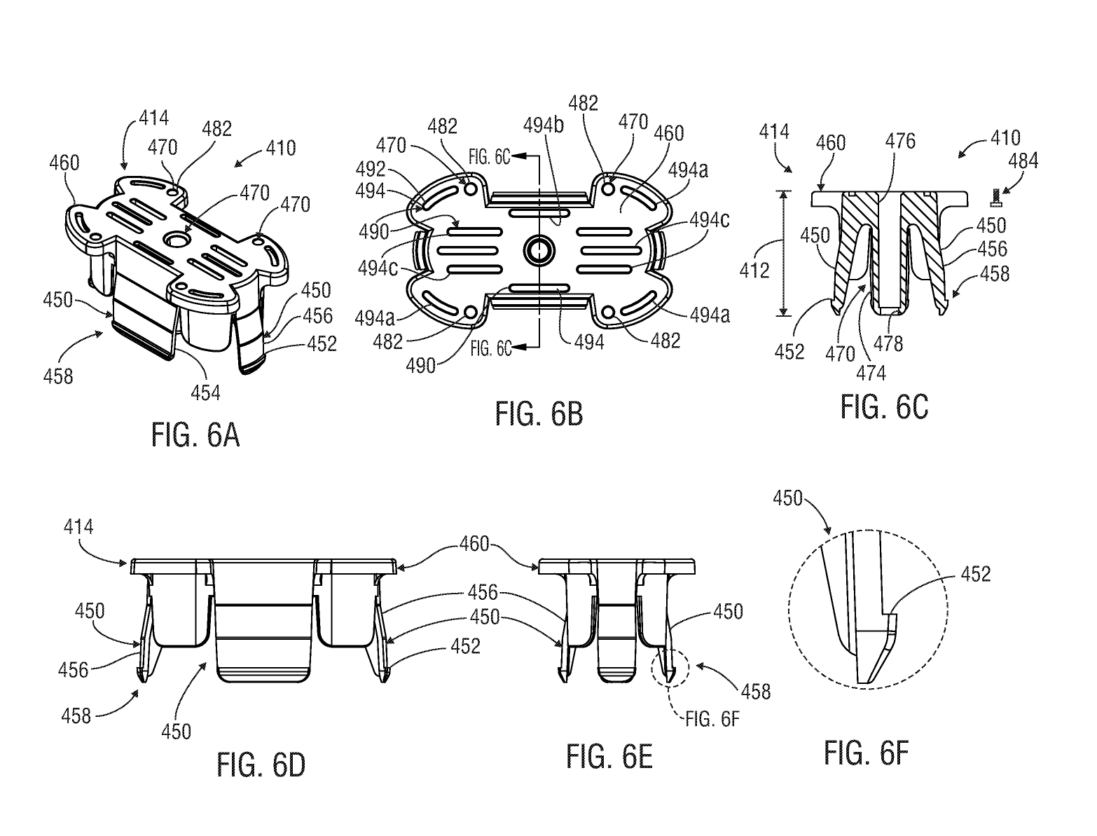

The base 410 may be sufficiently seated in the locking pin hole 32 or other hole or opening of the support surface 16 in any suitable manner. For example, referring to FIGS. 6A-F, the accessory base 410 may include at least two releasable grippers 450 shaped, sized, configured and positioned to releasably engage the wall(s) of the locking pin hole 32 (e.g. FIG. 5B). The grippers 450 may have any suitable form, components, configuration, construction and operation. For example, the accessory base 410 may include multiple grippers 450 that extend downwardly from a main body 460 of the accessory base 410 to each engage a distinct portion of the wall(s) of the locking pin hole 32 (e.g. FIG. 5B). In this particular embodiment, the grippers 450 are in the form of legs extending downwardly from the main body 460 at different locations around the perimeter thereof. The illustrated base 410 includes a pair of side grippers 454 and a pair of end grippers 456, each extending downwardly and angularly outwardly from the main body 460 to be friction fit or biased into engagement with the wall(s) of the locking pin hole 32. For example, the side grippers 454 may be wider than the end grippers 456 (e.g. when the base 410 is oval shaped) to provide the necessary desired engagement with the wall(s) of the exemplary (e.g. oval-shaped) hole(s) 32.

In some embodiments, the grippers 450 may snap into releasable, locking engagement with the wall(s) of the hole 32 as the base 410 is lowered or pushed into the hole 32 (e.g. FIG. 5B). In various embodiments, the opposing respective pairs of grippers 454, 456 may be squeezed, biased or compressed inwardly (toward one another) into releasable, locking engagement with the wall(s) of the hole 32. In many embodiments, an insertion and/or removal tool may be used to bias, friction fit or otherwise move the grippers 450 into and/or out of engagement within the hole 32. For example, the insertion and/or removal tool may include or or more manual, or hand-held, grippers or automated or robotic arms having one or more prongs extending therefrom and releasably engageable with the base 410. Likewise, any other suitable technique for engagement of the base 410 and the support surface 16 may be used.

If desired, one or more of the grippers 450 may include one or more lips 452 shaped and positioned to engage the mat 26 at the locking pin hole 32 (e.g. FIG. 5B). In this embodiment, as shown in FIGS. 6A-F, each gripper 450 includes an outwardly-extending lip 452 located proximate to the lower end 458 thereof and shaped, positioned and arranged to extend into the indentation 33 (e.g. FIG. 5B) formed in the lower surface 29 of the mat 26 around the locking pin hole 32.

Referring to FIGS. 6A-F, the illustrated main body 460 of the accessory base 410 may have any suitable form, configuration, components, construction and operation. In this example, the main body 460 is formed in an overall generally oval shape to sufficiently align the side and end grippers 454, 456 with the respective corresponding portions of the exemplary (e.g. oval-shaped) locking pin hole 32. However, in other embodiments, the base 410 may have an overall generally square, rectangular, circular, hexagonal or other shape, as desired.

The accessory base 410 may include at least one connection interface 470 for permanent or releasably connection with the accessory housing 420 and/or vertical assembly 430. The connection interface(s) 470 may have any suitable form, configuration, components, construction and operation. In this embodiment, as shown in FIG. 6C, the base 410 includes a connection interface 470 in the form of a vertically oriented sleeve 474 extending downwardly from the main body 460 in the approximate center of the base 410 for holding the vertical assembly 430. The sleeve 474 may have any suitable form, configuration, components, construction and operation. The illustrated sleeve 474 includes a bore 476 within which a portion of the vertical assembly 430 (e.g. the lower end of the carrier rod 432, FIG. 5B) is releasably insertable and anchored. If desired, the sleeve 474 (or other connection interface 470) may grip or otherwise engage the vertical assembly 430 (e.g. carrier rod 432, FIG. 5B) in rigid and/or locking engagement. For example, the carrier rod 432 may be friction fit into engagement with the interface 470, the carrier rod 432 and/or interface 470 may be formed with protruding grippers (e.g. pimples or ridges) and/or corresponding mating portions (e.g. mating slot(s)/protrusion(s)).

Referring to FIG. 6C, in this embodiment, the sleeve 474 and its bore 476 extend down to a position generally aligned with the lower end 458 of the grippers 450. If desired, the sleeve 474 may include at least one lip 478 extending into, or forming the end of, the bore 476 for supporting the lower end 436 (e.g. FIG. 9B) of the carrier rod 432 or other component of the vertical assembly 430. In other embodiments, the sleeve 474 may be angularly oriented, may not be in the center of the accessory base 410, may not extend to the level of the lower end 458 of the grippers 450, may not include a lip 478, or a combination thereof. In some embodiments, multiple sleeves 474 may be included.

In various embodiments, the connection interface(s) 470 in the accessory base 410 for the vertical assembly 430 may instead include one or more sleeves 474 extending upwardly from the main body 460. In yet other embodiments, the connection interface(s) 470 for the vertical assembly 430 may instead include one or more openings in the main body 460 within which a portion of the vertical assembly 430 may be snapped into or otherwise engaged.

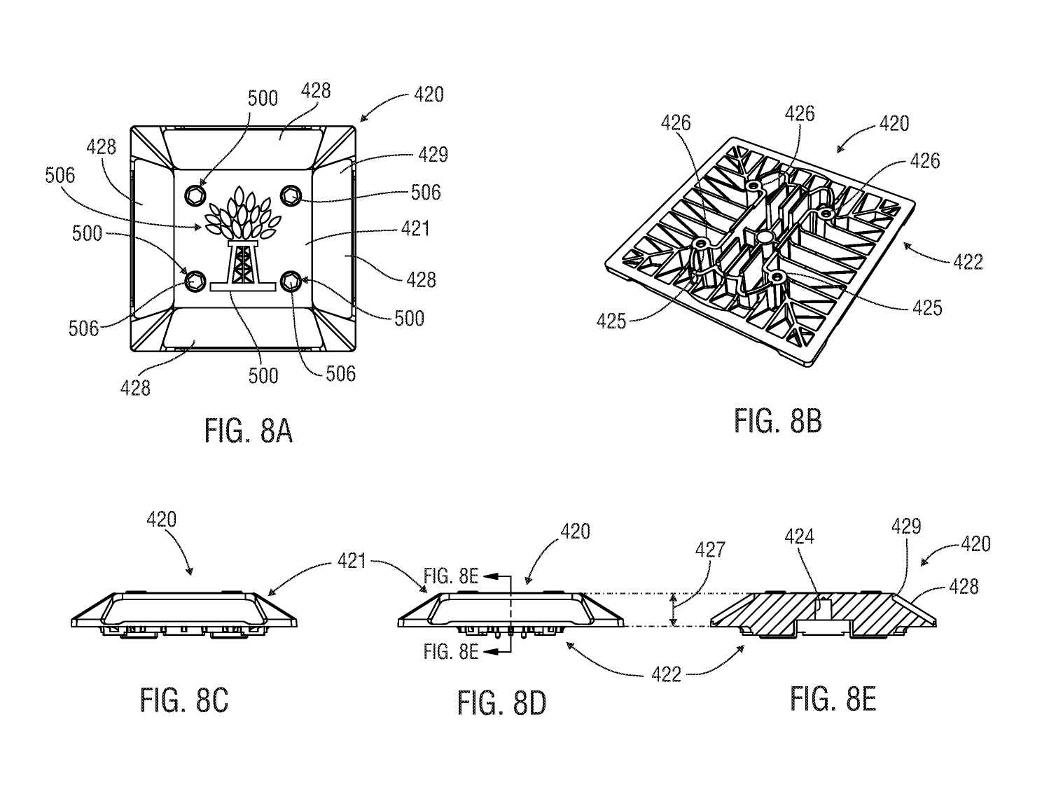

Referring again to FIGS. 6A-F, the accessory base 410 may also or instead include one or more interfaces 470 for permanent or releasably connection with the accessory housing 420. In this embodiment, multiple interfaces 470 in the form of anchor holes 482 are formed in the main body 460 for releasable connection with the accessory housing 420. For example, the main body 460 may include four spaced-apart anchor holes 482 extending therethrough, each configured to releasably receive a connector 484 (e.g. screw, bolt, pin (e.g. FIGS. 5C, 6C, 7D and 14D)) coupled between the main body 460 and accessory housing 420. In this embodiment, each anchor hole 482 is threaded and extends vertically through the main body 460 to receive a connector 484 inserted upwardly from beneath the main body 460 and up into and through it and then into a receiver 425 (e.g. FIG. 8B) of the housing 420. Thus, when assembled, the head of each exemplary connector 484 would abut the underside of the main body 460. In other embodiments, one, two, three, five or more anchor holes 482 may be included and the connector(s) 484, if included, may engage the accessory base 410 and housing 420 from above or otherwise as desired. In various embodiments, the connection interface(s) 470 in the accessory base 410 may include male, female or other snap-fitting couplers engageable with respective associated mating couplers on the accessary housing 420.

Still referring to FIGS. 6A-F, if desired, adhesive may also be used for coupling the accessory base 410 and accessory housing 420. In other embodiments, the interfaces 470 of the base 410 for permanent or releasably connection with the accessory housing 420 may be upwardly facing surfaces on the upper end 414 of the base 410 upon which adhesive is placed for coupling the base 410 to the accessory housing 420.

Still referring to FIGS. 6A-F, if desired, the accessory base 410 may include one or more insertion and/or removal tool receivers 490. The insertion and/or removal tool receivers(s) 490 may have any suitable form, configuration, components, construction and operation. For example, the main body 460 may include multiple insertion and/or removal tool receivers 490 in the form of tool engagement openings 492. In this embodiment, the tool engagement openings 492 are spaced-apart slots 494 shaped and positioned to receive a series of prongs from an insertion and/or removal tool used to grip and move the accessory base 410 into and/or out of engagement with the wall(s) of the locking pin hole 32 (e.g. FIG. 5B). For example, referring to FIG. 6B, one or more slots 494a may be positioned proximate to the outer edges of the accessory base 410, one or more slots 494b may be positioned proximate to the center of the base 410, one or more slots 494c may be positioned between the center and outer edges of the base 410, or a combination thereof.

Referring again to FIG. 5B, the exemplary accessory base 410 is formed with a height 412 (e.g. FIG. 6C) so that when it is engaged with the support surface 16, its upper end 414 lies at the desired height relative to the support surface 16. For example, it may be desirable for the upper end 414 of the base 410 to (i) lie below the upper surface 27 of the mat 26 when the mat 26 adjacent to the locking pin hole 32 (or other hole or cut-out in the support surface 16) includes raised traction promoting elements, or treads, 31, such as shown in FIGS. 5B, 9B, 12B and 14B-C, and/or (ii) generally align or be flush with the upper surface 27 of the mat 26 when the mat 26 adjacent to the locking pin hole 32 (or other hole or cut-out) does not include raised traction promoting elements, or treads, 31, such as shown in FIGS. 7B-C, 10B-C and 11A-B. In some embodiments, the same base 410 may be used in both scenarios, positioning the housing accessory(ies) 500 at the desired position(s) relative to the upper surface 27 of the mat 26 in both scenarios and adding durability to the system 400. In FIG. 5B, for example, the accessory base 410 is shown secured in a hole 32 formed in the upper lip 46 of the exemplary mat 26. Since the upper lip 46 of the exemplary mat 26 has treads 31 surrounding the hole 32, the upper end 414 of the illustrated accessory base 410 lies below the upper surface 27 of the adjacent mat 26. In FIG. 7C, the same exemplary accessory base 410 is shown used in a hole 32 formed in the lower lip 54 of the exemplary mat 26. Since the exemplary lower lip 54 does not have raised traction promoting elements, or treads, 31, the upper end 414 of the base 410 is generally aligned with the upper surface 27 of the mat 26.

Referring now to FIGS. 7A-D, the accessory housing 420 may have any suitable form, configuration, components, construction and operation. In this embodiment, the housing 420 is a single integrally-formed, molded-plastic component. In other embodiments, the housing 420 may be multiple components temporarily or permanently coupled together and constructed of any other desired material.

As shown in FIGS. 8A-E, the illustrated housing 420 includes a top side 421 useful for carrying or displaying one or more housing accessories 500, an underside 422 engageable with the accessory base 410 and a thickness 427. The thickness 427 may be selected so that the accessory housing 420 and any housing accessories 500 carried thereby are positioned as desired above, flush with or below the support surface 16 (e.g. FIGS. 5A-B, 7A-B). In some embodiments, for example, it may be desirable to position the housing accessory(ies) 500 proximate to or just above the upper surface 27 of the mat 26.

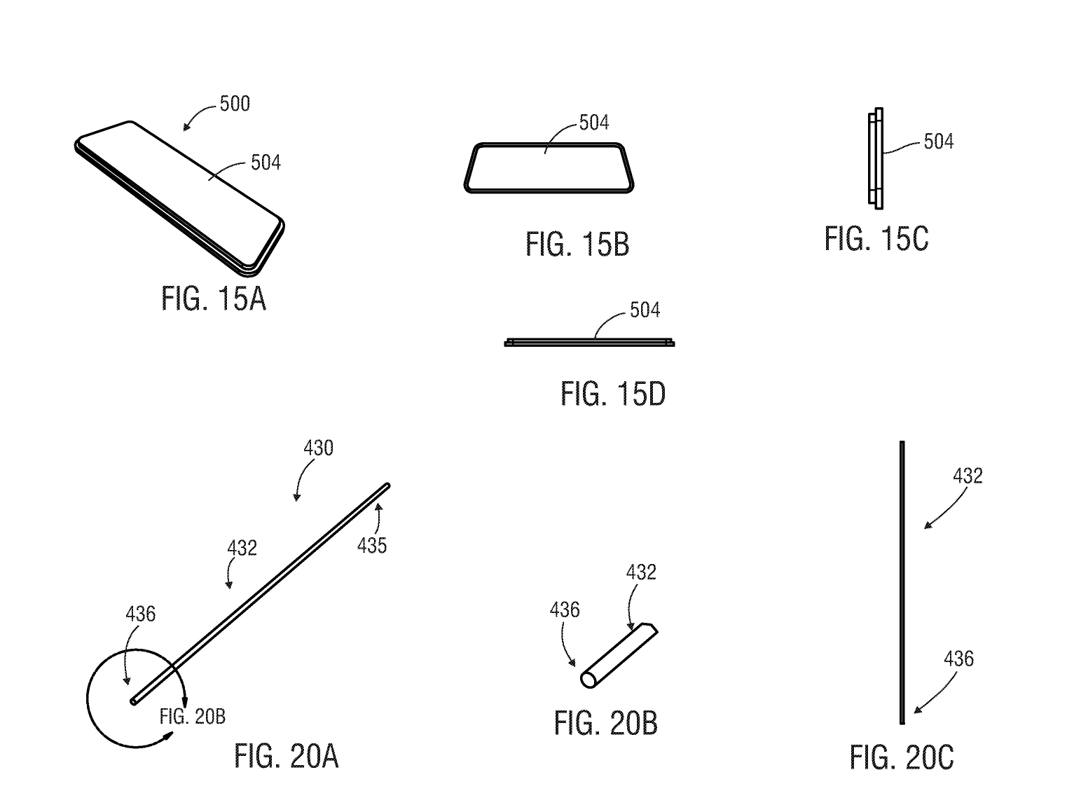

The accessory or accessories 500 carried or displayed by the accessory housing 420 may have any suitable form, configuration, components, construction and operation. For example, the housing accessory 500 may be one or more road-reflectors 504 (e.g. FIGS. 7A-C), as are and become further commonly known. An example of a presently commercially available road reflector 504 (e.g. FIGS. 15A-D) useful in connection with this embodiment is the Apex Model 921 lens offered by Apex Universal, Inc.

Still referring to FIGS. 8A-E, in this example, the top side 421 of the accessory housing 420 includes four outwardly angled faces 428, each configured to accept a road reflector 504. For example, each face 428 may have an indentation 429 shaped to receive a correspondingly-shaped road reflector 504 (e.g. FIGS. 5A-D). In this embodiment, a distinct road reflector 504 is bonded, such as with adhesive, to each indentation 429. The angle of the faces 428 may be selected to provide the desired visible angle of reflection for each road reflector 504 when the support surface accessory system 400 is used with a support surface 16. However, more or less than four (e.g. 1, 2, 3, 5, 6 etc.) faces 428 or other portions used to carry one or more accessory 500 may be included on the housing 420.

Another example housing accessory 500 is one or more images 506, such as a company or other name or logo, another symbol or any other discernible text. In this embodiment, a housing accessory 500 in the form of an image 506 of the company “drilling tree” logo of the present applicant, Newpark Mats & Integrated Services LLC, is molded into the top side 421 of the housing 420. Another example housing accessory 500 shown in this embodiment includes the images 506 of (faux) bolt heads also molded into the top side 421 of the housing 420. However, the present disclosure is not limited by the type, number or other characteristics of accessories 500 releasably or permanently carried by or affixed to the accessory housing 420. For a few other examples, the housing accessory 500 may be a light, beacon or other light-providing assembly, a siren or other sound-providing assembly.

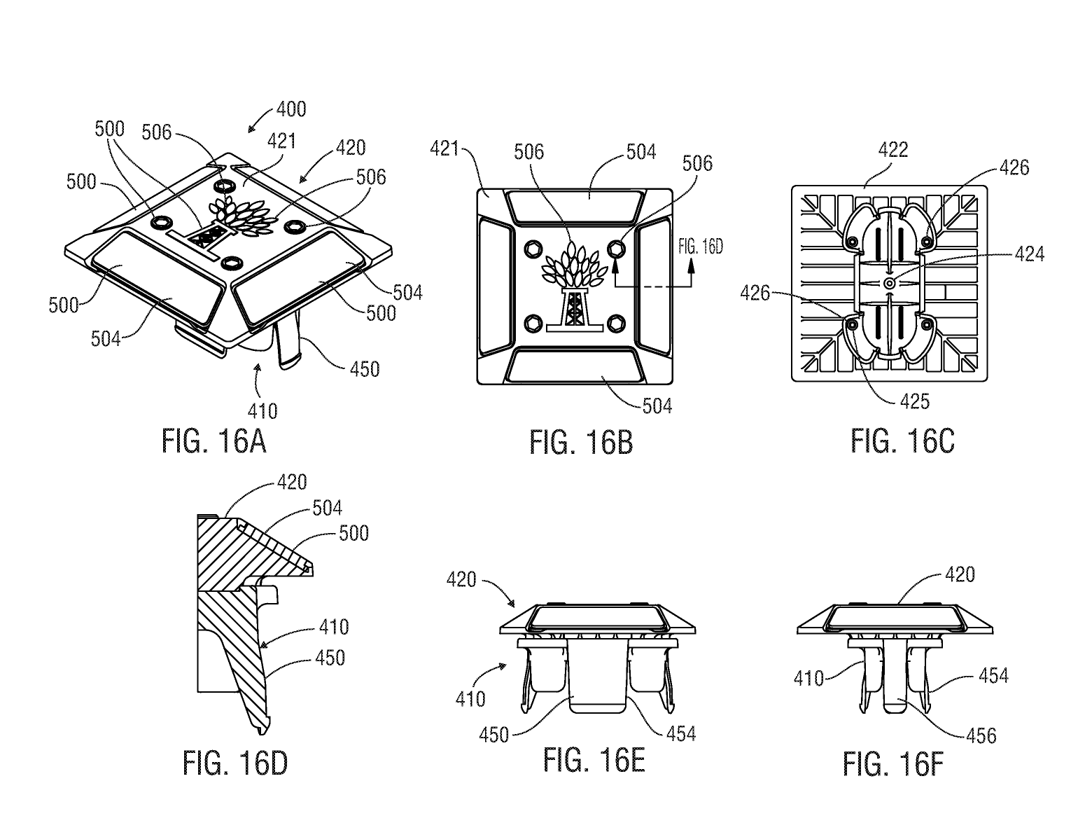

Still referring to FIGS. 8A-E, the accessory housing 420 may be engageable with the accessory base 410 in any suitable manner. In this embodiment, the underside 422 of the housing 420 includes four connector receivers 425, each shaped, arranged and configured to receive a connector 484 coupled with the accessory base 410 (e.g. FIGS. 5C, 6C, 7D). For example, each illustrated receiver 425 is a threaded, vertically-oriented, downwardly extending boss 426 configured to receive and engage a connector 484. The exemplary bosses 426 do not extend through the entire thickness 427 of the housing 420 and thus do not disturb the appearance of, or any functional features that may be provided on, the top surface 421 of the housing 420. However, other embodiments may include connector receivers 425 that extend through the entire thickness 427 of the housing 420, or have any other suitable configuration and operation as desired. When coupled to the base 410 (e.g. FIGS. 16A-F), the exemplary accessory housing 420 is rigidly connected in locking engagement so that it does not move relative to the base 410 and extends above the upper surface 27 of the adjacent mat 26 as desired (e.g. FIGS. 5B, 7C, and 14B).

Referring to FIG. 5B, if the support surface accessory system 400 is capable of including both at least one accessory housing 420 and at least one vertical assembly 430, the accessory housing 420 may be configured to be adaptable to accommodate the vertical assembly(ies) 430, if desired. For example, the accessory housing 420 may be configured to accept or accommodate one or more carrier rods 432 of the vertical assembly(ies) 430. In this embodiment, the accessory housing 420 includes one or more passageways 423 positioned, shaped and configured to allow the passage of a carrier rod 432 through the housing 420 and into the accessory base 410. If desired, as shown in FIGS. 7C, 8E and 14C, the housing 420 may be pre-formed with at least one partial passageway 424 that does not extend through the top side 421 thereof, but which can be later extended through the entire thickness 427 of the housing 420 to form a passageway 423 that accommodates a vertical assembly 430. Thus, the illustrated housing 420 can be used in a system 400 not having a vertical assembly 430 (so that the partial passageway 424 will not disturb the top side 421 of the housing 420), but can be easily adapted to later accommodate one or more vertical assemblies 430.

Referring back to FIGS. 5A-C, the vertical assembly 430 may have any suitable form, configuration, components, construction and operation. In this example, carrier rod 432 is shaped, sized and configured to engage the accessory base 410 and position the raised-position accessory(ies) 434 at the desired height over the support surface 16. The carrier rod 432 may have any suitable form, configuration, components, construction and operation and may engage the base 410 in any suitable manner. In this example, the carrier rod 432 (e.g. FIGS. 20A-C) is an elongated, solid, linear staff, or pole, constructed of durable material, such as plastic. In other embodiments, the carrier rod 432 may be hollow or include hollow portions, perforated or include one or more holes (e.g. for connection with other components), be curved or have a non-linear shape and/or constructed or metal, composite or other material. For other examples, the carrier rod 432 may include multiple sections, branches or components. For yet other examples, the carrier rod 432 may not be elongated and have any desired length and width dimensions.

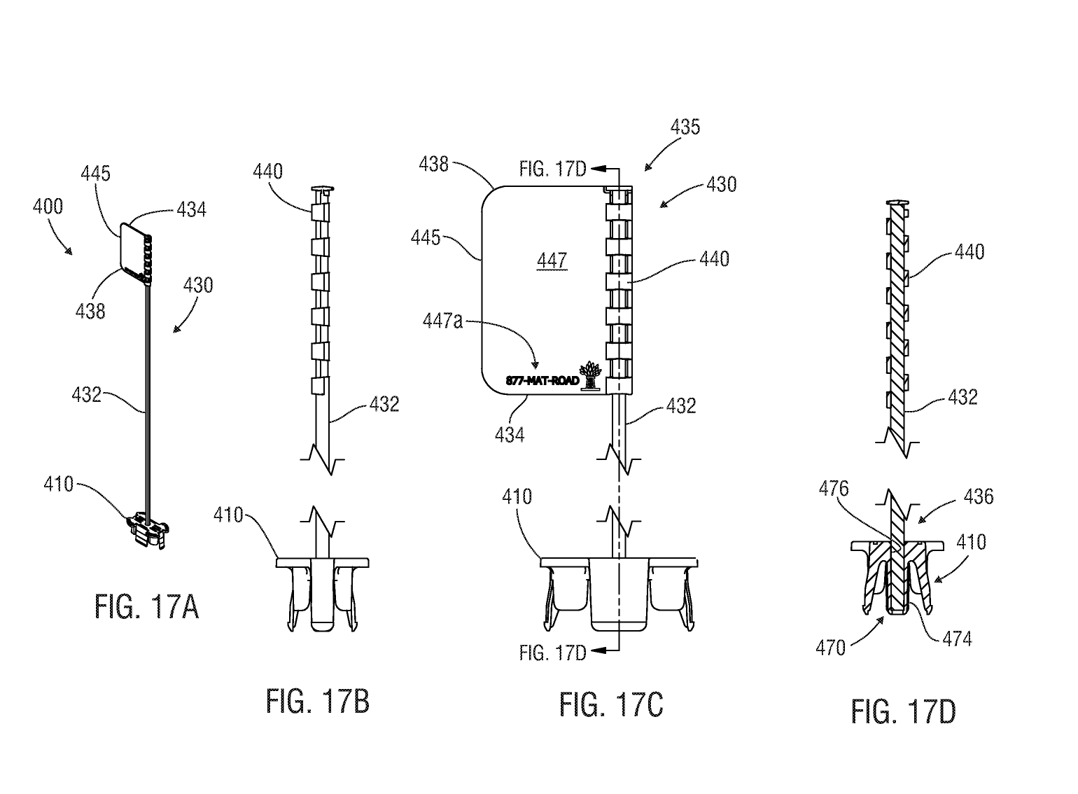

As shown in FIG. 9B, the lower end 436 of the exemplary carrier rod 432 is configured to engage the associated connection interface 470 of the accessory base 410. For example, the lower end 436 of the rod 432 may be shaped and sized to be releasably pressed, snap, or friction fit into the bore 476 of the sleeve 474 of the base 410 (e.g. FIGS. 17A-D). If desired, the carrier rod 432 may fit rigidly (e.g. snugly and securely) within the sleeve 474, such as to ensure it will not move relative thereto during normal or expected operating and environmental conditions. If desired, the carrier rod 432 may be glued, or bonded, within the sleeve 474, such as with suitable adhesive or glue to form a semi-permanent connection (e.g. with a releasable bonding agent) or permanent connection, as desired.

In the present embodiment, such as shown in FIG. 9B, the illustrated carrier rod 432 is rigidly engaged in the sleeve 474 of the accessory base 410 so that the lower end 436 thereof rests upon the lip 478 of the sleeve 474 and aligns proximate to the lower end 458 of the exemplary grippers 450. In the embodiment of FIG. 5B, since the support surface accessory system 400 also includes an accessory housing 420, the exemplary carrier rod 432 also extends through the passageway 423 of the illustrated housing 420. When used with embodiments of the support surface accessory system 400 that do not include at least one accessory housing 420, such as shown in FIGS. 9A-12C, the illustrated carrier rod 432 extends only into the sleeve 474 (or other connection interface 470) of the respective associated accessory base 410.

Referring again to FIGS. 5A-C, the raised-position accessory 434 of the exemplary vertical assembly 430 may have any suitable form, configuration, components, construction and operation. In some embodiments, the vertical assembly 430 may include multiple raised-position accessories 434. In this example, the raised-position accessory 434 is a marker 438, such as a sign or flag (see also FIGS. 17A-D). Other potential examples of raised-position accessories 434 are road reflectors, lights, beacons or other light-providing assemblies, sirens or other sound-providing assemblies.

In some embodiments, the raised-position accessory(ies) 434 may be positioned at any desired location(s) on the height of the carrier rod 432. In this example, the marker 438 is shown positioned at the upper end 435 of the illustrated carrier rod 432. However, the marker 438 and/or other raised-position accessories 434 may be positioned at other or multiple locations on the carrier rod 432, as desired. For example, a marker 438 may be placed at the upper end 435 of the carrier rod 432 and another raised-position accessory 434 (e.g. a beacon) may be positioned on the carrier rod 432 between its upper and lower ends 435, 436. For another example, multiple markers 438 may be stacked or placed at different heights along the carrier rod 432.

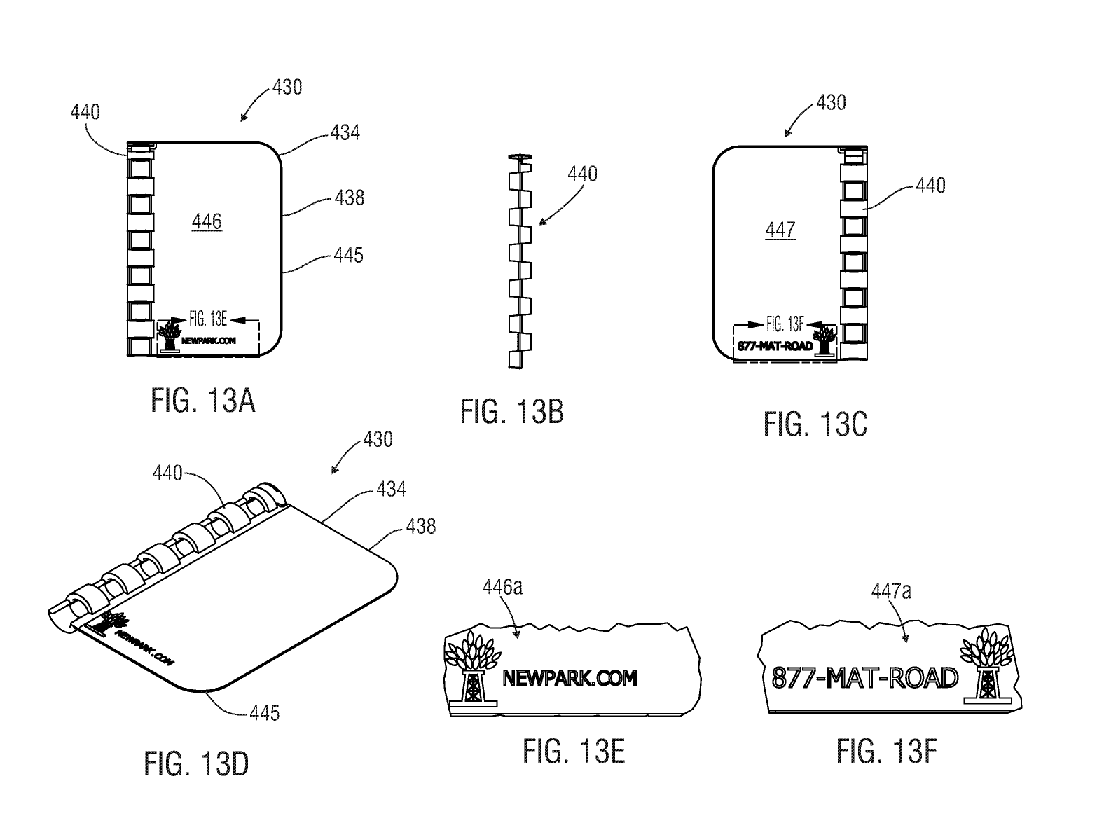

Referring again to FIG. 5B, when the raised-position accessory 434 includes at least one marker 438, the marker 438 may have any suitable form, configuration, components, construction and operation. In this example, as shown in FIGS. 13A-F, the marker 438 includes a sleeve 440 and a plate 445 extending laterally from the sleeve 440. If desired, the sleeve 440 and plate 445 may be integrally formed as a single component, such as via plastic molding.

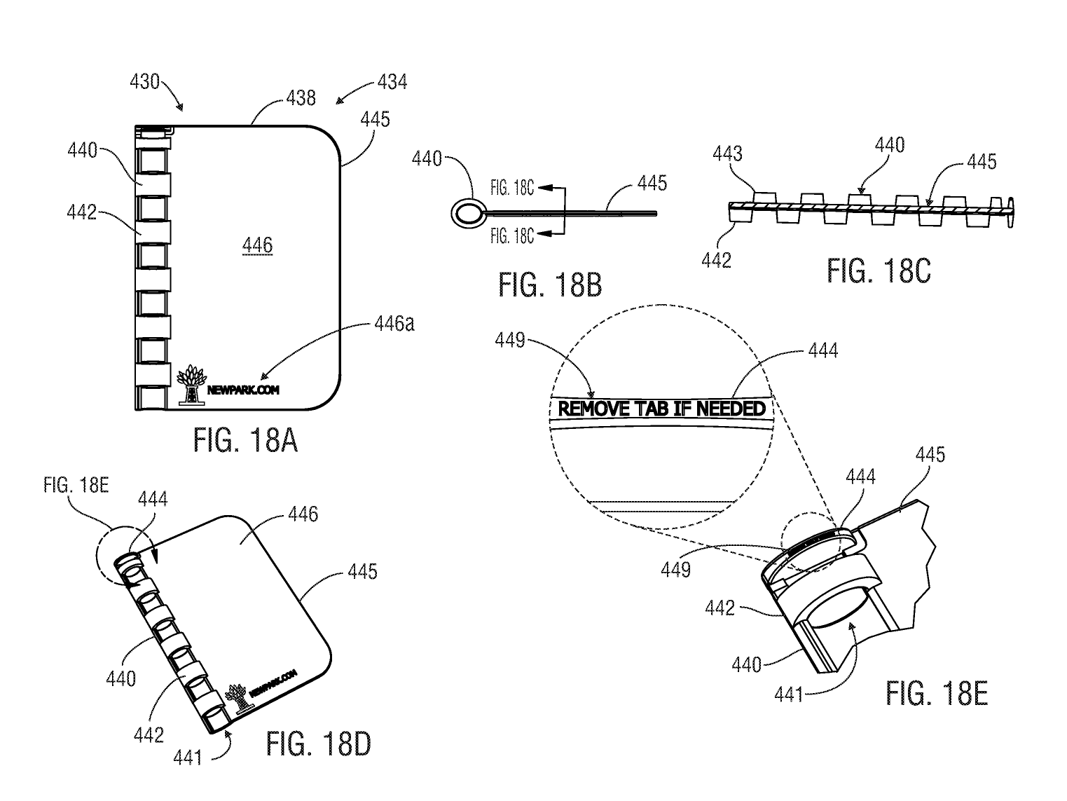

The illustrated sleeve 440 is shaped and sized to engage the carrier rod 432 as desired. For example, the exemplary sleeve 440 has a central bore 441 (e.g. FIG. 18D) for insertion over and onto the rod 432. In this example, the sleeve 440 fits rigidly (e.g. snugly) onto the rod 432 so that the marker 438 does not move relative to the rod 432. However, in other embodiments, the sleeve 440 may be configured to be movable relative to the rod 432. For example, the sleeve 440 may rotate (e.g. under sufficient wind forces) around the rod 432, if desired.

Referring to FIGS. 18A-E and 19A-E, if desired, the sleeve 440 may be formed with half-ring shaped front and rear sides 442, 443, respectively, such as for aesthetic, easy-of-manufacture or other desired purpose(s). In this embodiment, a retaining tab, or cap, 444 (e.g. FIG. 18E) is provided at the upper end of the sleeve 440 (e.g. FIG. 5A), such as to engage the top of upper end 435 of the carrier rod 432 and position the marker 438 at the top of the carrier rod 432. When included, if desired, the cap 444 could be removable, such as by being snapped off, such as to move the marker 438 down the rod 432 to a desired height, allow for multiple markers 438 and/or other vertical accessories 430 to be placed upon the rod 432 or other desired purpose. The cap 444 may include any text or graphics 449, such as shown in FIG. 18E, if desired.

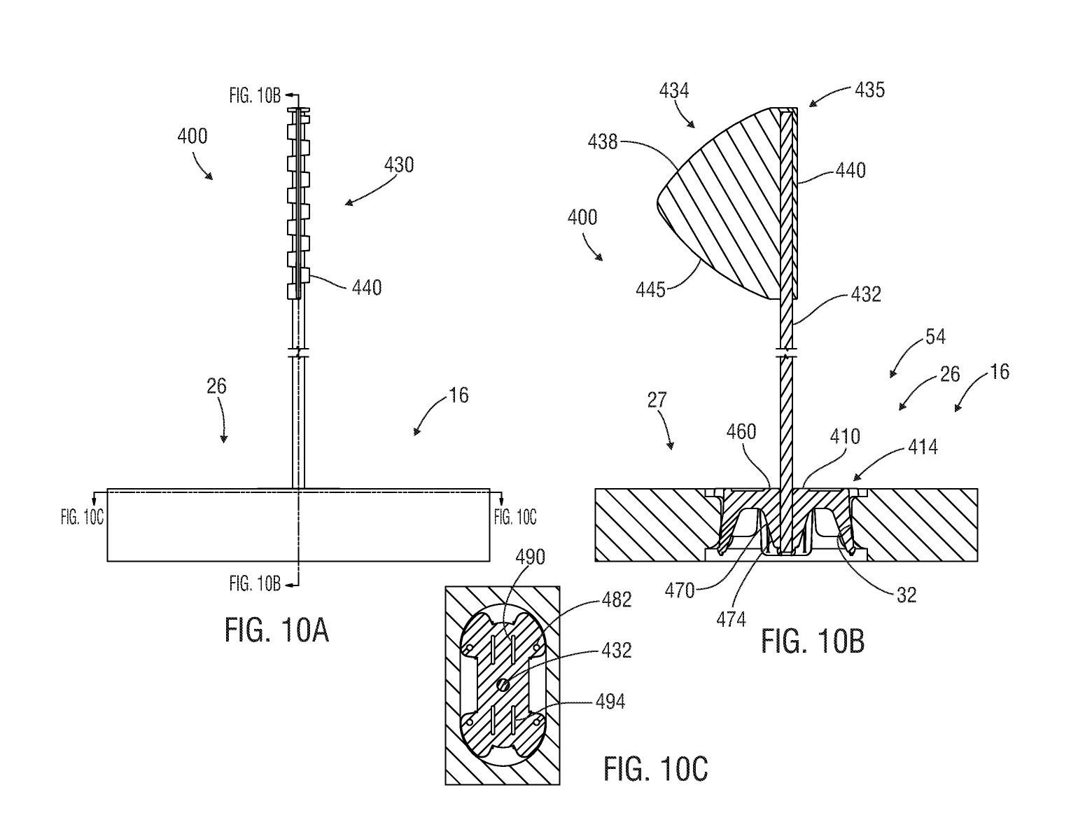

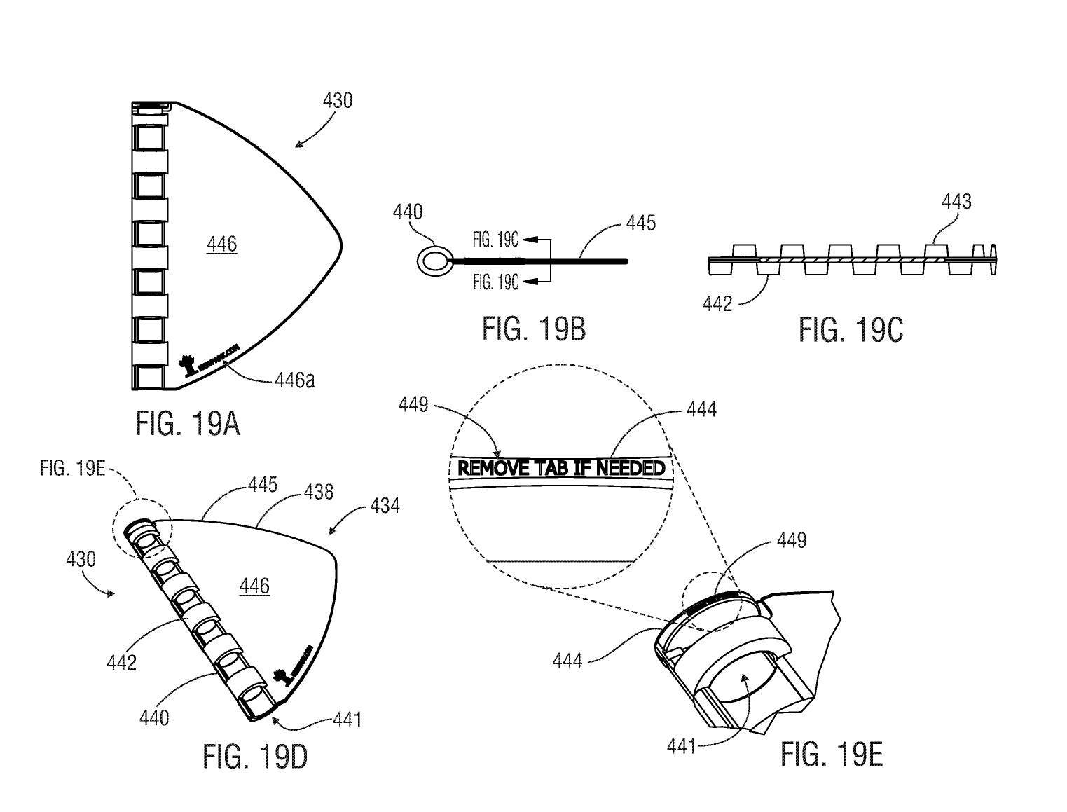

Referring again to FIGS. 18A-E, the plate 445 of the marker 338 may have any suitable form, configuration, components, construction and operation. In this embodiment, the plate 445 has an overall rectangular shape and is rigid and solid (see also FIGS. 9B, 11B, 13A, 17C). For other examples, the plate 445 may have a flag or triangular shape (e.g. FIGS. 10B, 12B, 19A-E), may be flexible and may have cut-out portions or holes formed therein. Likewise, the plate 445 may include any desired raised-position accessory(ies) 434, such as data, signage, one or more reflectors, lights, beacons, sirens, etc. releasably or permanently displayed, provided or mounted thereon. For example, the plate 445 may provide a visible color (e.g. orange to designate warning, company colors, etc.), activity or identification data (equipment identifier (e.g. “Rig No. 3021”)), location information (e.g. “Liquid Disposal Area”), company or personnel information (e.g. “Staging Area for Team 5”), directional indication or other guidance, or any other information or data. In this embodiment, as shown in FIGS. 13A-F, the plate 445 includes a front face 446 and a rear face 447 bearing different data. For example, the illustrated front face 446 bears data 446a (e.g. the web address “NEWPARK.COM” and logo of applicant Newpark Mats & Integrated Services LLC) and the rear face 447 bears data 447a (the phone number “877-MAT-ROAD” and logo of applicant Newpark Mats & Integrated Services LLC).

Thus, the present disclosure offers exemplary support surface accessory systems 400 and method that are useful for providing one or more accessories 434 and/or 500 in connection with a support surface 16, offer different options for the type and location of the accessories, includes components (e.g. base 410, housing 420, vertical assembly 430) which are interchangeable, easily coupled to and removed from the support surface 16 and replaced, reusable, durable, effective during typical expected use conditions, or a combination thereof.

Preferred embodiments of the present disclosure thus offer advantages over the prior art and are well adapted to carry out one or more of the objects of this disclosure. However, the present invention does not require each of the components and acts described above and is in no way limited to the above-described embodiments or methods of operation. Any one or more of the above components, features and processes may be employed in any suitable configuration without inclusion of other such components, features and processes. Moreover, the present invention includes additional features, capabilities, functions, methods, uses and applications that have not been specifically addressed herein but are, or will become, apparent from the description herein, the appended drawings and claims.

The methods that may be described above or claimed herein and any other methods which may fall within the scope of the appended claims can be performed in any desired suitable order and are not necessarily limited to any sequence described herein or as may be listed in the appended claims. Further, the methods of the present invention do not necessarily require use of the particular embodiments shown and described herein, but are equally applicable with any other suitable structure, form and configuration of components.

While exemplary embodiments of the invention have been shown and described, many variations, modifications and/or changes of the system, apparatus and methods of the present invention, such as in the components, details of construction and operation, arrangement of parts and/or methods of use, are possible, contemplated by the patent applicant(s), within the scope of any appended claims, and may be made and used by one of ordinary skill in the art without departing from the spirit or teachings of the invention and scope of this disclosure and any appended claims. Thus, all matter herein set forth or shown in the accompanying drawings should be interpreted as illustrative, and the scope of the disclosure and any appended claims should not be limited to the embodiments described and shown herein.

1. A system for providing multiple accessories on a support surface, the support surface having at least one hole extending at least partially therethrough, the system comprising:
a base configured to be at least partially inserted into at least one hole of the support surface and releasably engaged with the support surface, said at least one base including at least one bore formed therein; and
a housing releasably engageable with said base, said housing configured to carry at least a first accessory; and
an elongated carrier rod configured to carry at least a second accessory and be at least partially, releasably, insertable into said at least one bore of said base and engaged with said base, wherein when said carrier rod is engaged with said base and said base is engaged with the support surface, said carrier rod will position said second accessory at a desired height above the support surface,
further wherein said housing and said carrier rod are configured so that one or the other may be engaged with said base or both said housing and said carrier rod may be concurrently engaged with said base,
further wherein said housing is configured to include at least one passageway formed therein, wherein when said housing and said carrier rod are concurrently engaged with said base, said at least one passageway of said housing extends through said housing and said carrier rod extends through at least one said passageway of said housing.

2. The system of claim 1 wherein said base, housing and carrier rod and removable from the support surface and reusable.

3. The system of claim 2 wherein said base is configured to snap into and out of rigid, locking engagement with the support surface and releasable therefrom, said housing is configured to be secured in rigid, locking engagement with said base and releasable therefrom, and said carrier rod is configured to be secured in rigid, locking engagement with said base and releasable therefrom.

4. The system of claim 3 wherein said at least one bore of said base extends through a vertically oriented sleeve formed in said base.

5. The system of claim 1 wherein said base includes at least one insertion and/or removal tool engagement opening.

6. The system of claim 5 wherein said at least one insertion and/or removal tool engagement opening includes multiple spaced-apart slots configured to each receive a prong of an insertion and/or removal tool, said tool configured to grip said base for movement into and/or out of engagement with the support surface.

7. The system of claim 1 wherein said base includes a main body and at least two legs extending downwardly therefrom, each said leg including at least one lip configured to engage the support surface adjacent to the at least one hole of the support surface.

8. The system of claim 7 wherein the at least one hole of the support surface is oval shaped, further wherein said base is oval shaped, includes first and second sides and first and second ends extending around the perimeter thereof, first and second legs extending downwardly from said first and second respective sides thereof and third and fourth legs extending downwardly from said first and second respective ends thereof, said first and second legs each having a width that is greater than the width of said third and fourth legs, respectively, further wherein said legs are configured to be friction fit, snapped or biased into engagement with the support surface adjacent to the at least one hole.

9. The system of claim 1 wherein the support surface includes at least one upper surface, further wherein said base and said housing are configured to position said first accessory proximate to at least one upper surface of the support surface.

10. The system of claim 9 wherein said base and said housing are releasably coupled together with at least first and second removable connectors, said first and second connectors being configured to extend up through at least first and second anchor holes formed in said base and into at least first and second connector receivers of said housing, respectively.

11. The system of claim 1 wherein said first accessory includes at least one reflector and said second accessory includes at least one marker.

12. The system of claim 1 wherein said first and second accessories each respectively include at least one among at least one logo, symbol or other data, signage, light, beacon or siren.

13. The system of claim 1 wherein said housing includes four outwardly angled faces, each said face configured to accept a different said accessory and position it at a desired angle relative to the support surface.

14. The system of claim 1 wherein said second accessory is configured to be positioned at any desired height along said carrier rod.

15. The system of claim 16 further including multiple said accessories each disposed at a different height on said carrier rod over the support surface.

16. The system of claim 1 wherein said second accessory includes at least one marker, each said marker including a sleeve and a plate extending laterally from said sleeve, said sleeve being configured to firmly, releasably engage said carrier rod.

17. The system of claim 16 wherein said carrier rod and said sleeve each have upper and lower ends, respectively, said sleeve being configured to slideably engage said carrier rod, further wherein said sleeve include a removable retaining tab provided at said upper end thereof and configured to rest atop said upper end of said carrier rod, wherein when said retaining tab is not removed from said sleeve, said marker is positionable proximate to the upper end of said carrier rod, further wherein when said retaining tab is removed from said sleeve, said marker is positionable on said carrier rod at a desired intermediate location between said upper and lower ends of said carrier rod, further wherein multiple said markers may be engaged with said carrier rod.

18. A system for providing multiple accessories on a support surface, the system comprising:
at least one mat at least partially forming the support surface, each said mat having at least one upper surface, at least one lower surface and at least one hole extending at least partially therethrough, each said mat being configured to support the weight and movement of personnel, vehicles and equipment thereupon;
an accessory base configured to be firmly, releasably secured into at least one hole of at least one of the mats, said at least one accessory base including at least one bore formed therein; and
an accessory housing configured to be firmly, releasably engaged with said accessory base, said accessory housing configured to carry at least a first accessory; and
an accessory carrier rod configured to be firmly, releasably engaged with said accessory base, configured to carry at least a second accessory and extend above said at least one upper surface of said at least one mat to position said second accessory at a desired height over said support surface.

19. The system of claim 18 wherein said accessory housing and said accessory carrier rod are configured so that one or the other may be engaged with said accessory base or both said accessory housing and said accessory carrier rod may be concurrently engaged with said accessory base, further wherein said accessory housing includes respective upper and lower surfaces and at least one partial passageway extending into said accessory housing from said lower surface to an intermediate location within said accessory housing, wherein when said accessory housing and said accessory carrier rod are concurrently engaged with said accessory base, said partial passageway is extendable through the entirety of said accessory housing from said lower surface to said upper surface thereof and said accessory carrier rod is extendable through at least one said passageway of said accessory housing and into at least one said bore of said accessory base.

20. A method of providing multiple accessories on a support surface, the support surface having at least one hole extending at least partially therethrough, the method comprising:
providing at least a first accessory on an accessory housing;
providing at least a second accessory on an accessory carrier rod spaced upwardly from the lower end of the accessory carrier rod;
releasably inserting the accessory base at least partially into at least one hole of the support surface and releasably, rigidly securing the accessory base to the support surface;
releasably, rigidly securing the accessory housing to the accessory base; and
releasably, inserting the lower end of the accessory carrier rod through at least one passageway formed in and extending through the accessory housing and into a bore extending at least partially through the accessory base and releasably, rigidly securing the accessory carrier rod to the accessory base.
